(19) United States
(12) Patent Application Publication
(10) Pub. No.: US 2024/0228797 A1
(43) Pub. Date: Jul. 11, 2024

(54) LIQUID REPELLENT SLIPPERY SURFACES AND METHODS OF PREPARATION THEREOF

(71) Applicant: University of Durham, Durham (GB)

(72) Inventors: Jas Pal Singh Badyal, Durham (GB); Harrison John Cox, Durham (GB); Claire Hatfield, Durham (GB); Joe McCrae Rawlinson, Durham (GB)

(21) Appl. No.: 18/563,274

(22) PCT Filed: May 27, 2022
(86) PCT No.: PCT/GB2022/051357

§ 371 Date: Nov. 21, 2023

(30) Foreign Application Priority Data
May 28, 2021 (GB) 2107626.0

(51) Int. Cl. C09D 5/16

(52) U.S. Cl. CPC C09D 5/1681; C09D 5/1675

(57) ABSTRACT

The present invention provides liquid repellent slippery surfaces and methods or preparing the same. The surface comprises a substrate, the substrate surface being functionalised via the deposition of a polymer layer thereon, and a lubricant impregnated into the polymer layer, thereby forming said liquid repellent slippery surface. The polymer layer comprises an aromatic ring-containing polymer layer; and the lubricant is an aliphatic compound, rapeseed oil, olive oil, vacuum pump oil, cinnamaldehyde a cinnamaldehyde derivative, essential oil or an essential oil-derived compound. The present invention also provides a liquid repellent slippery surface, wherein the surface comprises a substrate and associated substrate surface, the substrate surface functionalised via the deposition of a polymer layer thereon. The polymer layer is formed from a functional monomer precursor comprising a siloxane-group containing monomer or an alkyl-group containing monomer.

The invention to which this application relates is liquid repellent slippery surfaces and methods of preparation thereof.

Liquid repellent slippery liquid-infused porous surfaces (SLIPS) have been inspired by the carnivorous Nepenthes pitcher plant, in which a nectar film entrapped within a textured surface on the plant peristome is used to attract and capture arthropod prey. In the past, SLIPS have been fabricated by impregnating a roughened or porous surface with a lubricating liquid. The lubricant must be able to wet and adhere to the host surface in preference to the liquid which is being repelled, and the lubricant needs to be immiscible with the liquid being repelled. This has been achieved through careful matching of the solid surface and lubricant chemistries. Slippery lubricant-infused surfaces have been proposed for a wide variety of technological and societal applications including: water repellency, antibacterial, marine antibiofouling, blood repellency, icephobicity, anti-icing, corrosion resistance, prevention of short circuiting between electronic components, condensation control for heat exchange, flow in microfluidic devices, mineral fouling mitigation, droplet motion control, water harvesting, fog collection, antireflectivity, antifouling of foodstuffs, antifouling of fecal matter, underwater bubble transportation, and drag reduction. For the case of bacterial biofilm formation and surface fouling, the problem is of considerable societal importance, particularly in the healthcare and medical settings (for example, the vast majority of catheter-associated urinary tract infections are caused by biofilms formed on the catheters). In the marine environment on the hulls of ships, bacteria biofilm formation and fouling results in increased frictional drag, leading to more fuel consumption and greater greenhouse gas emissions. Bacteria biofilms are also of concern in the food industry, given their role in food spoilage and risks to public health. Therefore, eco-friendly lubricant-infused slippery surfaces are potential candidates for tackling a wide range of societal and environmental issues.

It has been shown that in the absence of any bactericidal additive, SLIPS do not possess the ability to kill bacteria. Therefore, typically an antimicrobial agent (for example drug molecules such as triclosan) needs to be impregnated into a pre-made SLIPS, or silver is incorporated into the substrate prior to lubricant infusion. However, environmental concerns exist about the toxicity of triclosan towards marine life, as well as its bioaccumulation, and the risk for bacteria to develop antimicrobial resistance towards the drug. Whereas silver (and silver compounds) typically has high costs when compared to organic compounds, and again there is concern about the emergence of antimicrobial resistance, as well as toxicity towards the environment and humans. Furthermore, many of the reported fabrication techniques for SLIPS systems are limited in the range and geometries of materials that they can be produced on. For example, hydrothermal treatment is applicable to inorganic surfaces such as aluminium and glass, whilst electroplating is restricted to metals, and the use of inherently porous or micro/nanostructured materials to infiltrate lubricants cannot be extended to non-porous materials. In the case of layer-by-layer deposition techniques, typically long coating times are required to build up a sufficient coating layer thickness. Also, these methodologies require multiple steps, and often need an extra substrate hydrophobization step in order to provide sufficient surface affinity towards the lubricant impregnation.

It is therefore an aim of the present invention to provide novel and effective liquid repellent slippery surfaces which overcome the aforementioned problems associated with the prior art.

It is another aim of the present invention to provide methods of preparing liquid repellent slippery surfaces which overcome the aforementioned problems associated with the prior art.

According to a first aspect of the invention there is provided a liquid repellent slippery surface, said surface comprising:
a substrate and associated substrate surface;
said substrate surface functionalised via the deposition of a polymer layer thereon; and
a lubricant impregnated into the polymer layer, thereby forming said liquid repellent slippery surface,
wherein said polymer layer comprises an aromatic ring-containing polymer layer, and said lubricant is an aliphatic compound, rapeseed oil, olive oil, vacuum pump oil, cinnamaldehyde a cinnamaldehyde derivative, essential oil or an essential oil-derived compound.

Typically, said liquid repellent slippery surface is provided to have antimicrobial, antibacterial, antifungal, antifouling, antibiofouling, antiviral, drag reduction and/or antiparasitic properties.

Typically, said liquid repellent slippery surface is defined as having a liquid contact angle hysteresis value of 10⁰ or less, and a liquid sliding angle of 10⁰ or less.

In one embodiment, said substrate is a non-porous substrate. Typically, said substrate comprises, polyethylene terephthalate (PET), polypropylene, polyethylene, polystyrene, polyvinyl chloride, nylon, Teflon/polytetrafluoroethylene, polyurethanes, polylactic acid, polyisoprene, polybutadiene, natural rubber, poly(methyl methacrylate), polyimides, any other plastics, copolymers, polysiloxanes; metals such as aluminium, copper, steel; wood, quartz, cotton, wool, ceramics, linoleum, paper/cellulose, cement, textiles, silicon wafer, glass or the like.

In some embodiments, said substrate may be a porous substrate on to which said polymer layer may be deposited. Typically, said porous substrate comprises non-woven polypropylene, polytetrafluoroethylene membrane (PTFE), polyethylene, polystyrene, polyester, polyvinyl chloride, nylon, Teflon/polytetrafluoroethylene, polyurethanes, polylactic acid, polyisoprene, polybutadiene, natural rubber, poly(methyl methacrylate, polyimides, copolymers, polysiloxanes; metals such as aluminium, copper, steel; wood, quartz, cotton, wool, ceramics, linoleum, paper/cellulose, cement, textiles such as knitted cotton, or the like.

Preferably, said polymer layer formed on said substrate surface forms a surface which is functionally compatible with and may be impregnated by said lubricant.

In one embodiment, said polymer layer is formed from aromatic ring-containing functional monomer precursors.

Typically, said polymer layer is formed from any functional monomer precursor from the group including: styrene, benzyl acrylate, vinylbenzaldehyde, vinylbenzyl chloride, perfluoroallylbenzene; pentafluorostyrene; vinylaniline, or vinylpyridine.

In one embodiment, said lubricant is antimicrobial, antibacterial, antifungal, antifouling, antibiofouling, antiviral and/or antiparasitic.

Typically, said lubricant is provided in liquid form.

In some embodiments, said lubricant is selected from the group including: squalane; hexadecane 2-methyl-undecanal; 1-undecanol; decanal; geraniol; perfluorotributylamine; perfluoropolyether; perfluorodecalin; rapeseed oil; olive oil; vacuum pump oil; cinnamaldehyde; a cinnamaldehyde derivative, essential oil or an essential oil-derived compound.

In some embodiments, said lubricant may comprise a liquid plus solid mixture. Typically, said liquid plus solid mixture may comprise nanoparticles and/or nanosheets dispersed within a liquid.

In some embodiments, said lubricant may comprise a liquid plus bioactive agent mixture. Typically, said liquid plus bioactive agent mixture may comprise an antimicrobial substance dispersed within a liquid, for example, an antimicrobial metallosurfactant.

In one embodiment, where the polymer layer is formed from the polymerisation of perfluoroallylbenzene, said lubricant is selected from the group comprising perfluorotributylamine, perfluoropolyether or perfluorodecalin.

In one embodiment, where the polymer layer is formed from the polymerisation of benzyl acrylate, vinylbenzaldehyde, vinylbenzyl chloride or vinylaniline said lubricant is selected from the group comprising cinnamaldehyde, a cinnamaldehyde derivative, citral, decanal, 2-methyundecanal, hexadecane, polygodial, an essential oil or an essential oil-derived compound. Typically, said cinnamaldehyde derivatives include 2-nitrocinnamaldehyde, 3,5-dimethoxy-4-hydroxycinnamaldehyde, 4-(diethylamino)cinnamaldehyde, 4-(dimethylamino)cinnamaldehyde, 4-acetoxy-3-methoxycinnamaldehyde, 4-bromocinnamaldehyde, 4-chlorocinnamaldehyde, 4-fluorocinnamaldehyde, 4-hydroxy-3-methoxycinnamaldehyde, 4-nitrocinnamaldehyde, o-methoxycinnamaldehyde, p-methoxycinnamaldehyde, supercinnamaldehyde, α-amylcinnamaldehyde, α-bromocinnamaldehyde, α-chlorocinnamaldehyde, α-hexylcinnamaldehyde, α-methylcinnamaldehyde, β-phenylcinnamaldehyde, or a derivative of any of these, or a mixture/combination thereof.

Typically, said essential oil may be selected from the group containing Agar oil or oodh, distilled from agarwood (Aquilaria malaccensis); Ajwain oil, from Carum copticum; Angelica root oil, from Angelica archangelica; Anise oil, Asafoetida oil, Balsam of Peru, Basil oil, Bay oil, Bergamot oil, Black pepper oil, Buchu oil, Birch oil, Camphor oil, Cannabis flower essential oil, Calamodin oil, Caraway seed oil, Cardamom seed oil, Carrot seed oil, Cedar oil (or cedarwood oil), Chamomile oil, Calamus oil, Cinnamon oil, Cistus ladanifer oil, Citron oil, Citronella oil, Clary Sage oil, Coconut oil, Clove oil, Coffee oil, Coriander oil, Costmary oil (bible leaf oil), Costus root oil, Cranberry seed oil, Cubeb oil, Cumin seed oil/black seed oil, Cypress oil, Cypriol oil, Curry leaf oil, Davana oil, Dill oil, Elecampane oil, Elemi oil, Eucalyptus oil, Fennel seed oil, Fenugreek oil, Fir oil, Frankincense oil, Galangal oil, Galbanum oil, Garlic oil, Geranium oil, Ginger oil, Goldenrod oil, Grapefruit oil, Henna oil, Helichrysum oil, Hickory nut oil, Horseradish oil, Hyssop oil, Tansy oil, Jasmine oil, Juniper berry oil, Laurus nobilis oil, Lavender oil, Ledum oil, Lemon oil, Lemongrass oil, Linseed oil, Lime oil, Litsea cubeba oil, Mandarin oil, Marjoram oil, Melissa oil (Lemon balm), Mentha arvensis oil (mint oil), Moringa oil, Mountain Savory oil, Mugwort oil, Mustard oil, Myrrh oil, Myrtle oil, Neem oil or neem tree oil, Neroli oil, Nutmeg oil, Orange oil, Oregano oil, Orris oil, Palo Santo oil, Parsley oil, Patchouli oil, Perilla oil, Pennyroyal oil, Peppermint oil, Petitgrain oil, Pine oil, Ravensara oil, Red Cedar oil, Roman Chamomile oil, Rose oil, Rosehip oil, Rosemary oil, Rosewood oil, Sage oil, Sandalwood oil, Sassafras oil, Savory oil from Satureja species, Schisandra oil, Spearmint oil, Spikenard oil, Spruce oil, Star anise oil, Tangerine oil, Tarragon oil, Tea tree oil, Thyme oil, Tsuga oil, Turmeric oil, Tung oil, Valerian oil, Warionia oil, Vetiver oil (khus oil). Western red cedar oil, Wintergreen oil, Yarrow oil, Ylang-ylang oil, or a mixture/combination thereof.

Typically, said essential oil-derived compounds may be selected from the group containing 3-carene, allyl isothiocyanate, anethole, berberine, borneol, camphene, carvacrol, carvacrol methyl ester, carvone, caryophyllene oxide, cedrol, cinnamaic acid, cis-hex-3-en-1-ol, citral, citronellal, citronellic acid, curcumin, eucalyptol, eugenol, farnesol, ferulic acid, geraniol, geranyl acetate, limonene, linalool, menthol, menthone, methyl salicylic acid, methyl salycilate, nerol, nerolidol, pinocarvone, polygodial, sabinene, terpinen-4-ol, terpineol, thujone, thymol, tropolone, verbenone, α-pinene, α-terpinene, α-terpineole, β-pinene, β-thujaplicin, or a derivative of any of these, or a mixture/combination thereof.

In one embodiment, where the substrate comprises porous non-woven polypropylene, said polymer layer is formed from the deposition of poly(vinylaniline) thereon.

In one embodiment, said liquid repellent surface is provided to have antimicrobial properties. Typically, said antimicrobial liquid repellent surface is formed wherein the lubricant comprises cinnamaldehyde or a cinnamaldehyde derivative, essential oil or an essential oil-derived compound.

In one embodiment, said liquid repellent slippery surface is provided to be omniphobic. Typically, said omniphobic surface is formed wherein the polymer layer comprises poly(perfluoroallylbenzene) and the lubricant comprises one of perfluorotributylamine, perfluoropolyether or perfluorodecalin.

Typically, the substrate surface may be functionalised by a range of different wet or dry (solventless) techniques, including, but not limited to: pulsed plasmachemical deposition; remote pulsed plasmachemical deposition; plasma enhanced chemical vapour deposition (PECVD); remote plasma enhanced chemical vapour deposition; initiated chemical vapour deposition (iCVD); atomised spray plasma deposition; plasma polymerization; electron/ion beam deposition; chemical vapour deposition (CVD); thermal chemical vapour deposition; liquid spray deposition; excited liquid spray deposition; photodeposition; ion-assisted deposition; electron beam polymerization; gamma-ray polymerization; or atomic layer deposition (ALD).

In a preferred embodiment, the substrate surface is functionalised by a dry (solventless) technique. Avoiding the use of wet techniques consequently removes the requirement for additional material such as solvent during the polymer layer deposition process.

In a preferred embodiment, the substrate surface may be functionalised via pulsed plasmachemical deposition.

Typically, said polymer layer is formed via pulsed plasma polymerisation of the monomer precursor onto said substrate surface. Further typically, said lubricant is impregnated into the deposited polymer layer to produce a slippery lubricant-infused surface.

Pulsed plasmachemical deposition entails two distinct reaction regimes: the short period on-time (tₒₙ—typically microseconds, where electrical discharge ignition leads to the formation of initiator radical species from the monomer), and then the longer period off-time (t_{off}—typically milliseconds, where conventional stepwise addition chain-growth monomer polymerisation proceeds). This culminates in excellent structural retention of the monomer functional groups to yield well-defined functional polymer nanocoatings. Key advantages of pulsed plasmachemical surface functionalisation include a simple and quick single-step process, ambient temperature, conformal 3-dimensional coating, independent of substrate material, excellent adhesion, solventless, minimal waste, and low energy consumption. A variety of different functional monomers have been utilised to fabricate a range of pulsed plasma deposited nanolayer surface chemistries for compatibilization with appropriate functional lubricants to yield a structure-behaviour relationship for slippery surface fabrication. Further fine tuning (molecular tailoring) of the surface compatibilization properties can be achieved by varying the pulsed plasma duty cycle parameters.

The present invention therefore provides a range of lubricant-infused liquid repellent slippery surfaces, which have been devised through combining different functional pulsed plasma polymer nanolayers and lubricants. This has led to the development of a molecular level structure-behaviour relationship highlighting favourable aromatic-aliphatic interactions between coatings and lubricants. Fluorinated lubricant-infused coatings display omniphobicity and are able to resist wetting by liquids spanning a wide range of surface tensions, including: pentane, motor oil, and water. In the case of natural antimicrobial compound-infused functional plasma polymer surfaces (for example the essential oil cinnamaldehyde), dual mode performance is observed comprising high liquid repellency in conjunction with strong antibacterial activity against both Gram-positive Staphylococcus aureus and Gram-negative Escherichia coli (Log₁₀ Reduction>7), discussed in further detail below. In addition, these lubricant-infused functional pulsed plasma polymer surfaces easily repel a variety of everyday liquids (including foodstuffs such as tomato ketchup and honey).

According to a further aspect of the invention there is provided a liquid repellent slippery surface, said surface comprising:
a substrate and associated substrate surface; and
a lubricant provided on the substrate surface, thereby forming said liquid repellent slippery surface;
wherein said substrate surface includes an aromatic ring-containing compound.

In one embodiment, said substrate surface is formed from a compound comprising aromatic ring-containing groups.

Typically, said substrate surface is formed from poly(styrene). In some embodiments, said substrate surface comprises a drop-cast poly(styrene) coating.

In another embodiment, said substrate, and hence substrate surface, is formed from poly(styrene).

In another embodiment, said substrate surface is functionalised via the deposition of a polymer layer thereon, said polymer layer formed from a functional monomer precursor containing an aromatic ring-containing group. Typically, the deposited polymer layer thereby forms the substrate surface having an aromatic ring-containing compound.

Typically, said polymer layer is formed from any functional monomer precursor from the group including: styrene, benzyl acrylate, vinylbenzaldehyde, vinylbenzyl chloride, perfluoroallylbenzene; pentafluorostyrene; vinylaniline, or vinylpyridine.

According to a further aspect of the invention there is provided a liquid repellent slippery surface, said surface comprising:
a substrate and associated substrate surface; and
a lubricant provided on the substrate surface, thereby forming said liquid repellent slippery surface;
wherein said substrate surface is formed from a compound comprising aromatic ring-containing groups or is functionalised via the deposition of a polymer layer thereon, said polymer layer formed from a functional monomer precursor containing an aromatic ring-containing group.

According to another aspect of the invention there is provided a liquid repellent slippery surface, said surface comprising:
a substrate and associated substrate surface;
said substrate surface functionalised via the deposition of a polymer layer thereon; and
a lubricant impregnated into the polymer layer, thereby forming said liquid repellent surface,
wherein said polymer layer is formed from any functional monomer precursor from the group including: styrene, benzyl acrylate, vinylbenzaldehyde, vinylbenzyl chloride, perfluoroallylbenzene; pentafluorostyrene; vinylaniline, or vinylpyridine; and said lubricant is selected from the group including: 11qualene; hexadecane 2-methyl-undecanal; 1-undecanol; decanal; geraniol; perfluorotributylamine; perfluoropolyether; perfluorodecalin; rapeseed oil; olive oil; vacuum pump oil; cinnamaldehyde; a cinnamaldehyde derivative, essential oil or an essential oil-derived compound.

In another aspect of the present invention, there is provided a method of preparing a liquid repellent slippery surface, said method including the steps of:
providing a substrate having an associated substrate surface;
functionalising the surface of the substrate via the deposition of a polymer layer thereon;
infusing or impregnating a lubricant into the polymer layer by immersing the polymer-coated substrate into a solution or liquid form of said lubricant for a predetermined period of time;
removing the substrate from the solution or liquid form of said lubricant;
washing, and subsequently drying the substrate to provide the same with the liquid repellent surface thereon, and
wherein said polymer layer comprises an aromatic ring-containing polymer layer, and said lubricant is an aliphatic compound, rapeseed oil, olive oil, vacuum pump oil, cinnamaldehyde, a cinnamaldehyde derivative, essential oil or an essential oil-derived compound.

Preferably, said polymer layer formed on said substrate surface forms a surface which is functionally compatible with and may be impregnated by said lubricant.

In one embodiment said liquid repellent slippery surface is an antibacterial or antimicrobial coating and/or has hydrophobic or omniphobic characteristics.

Typically, said liquid repellent slippery surface is provided to have antimicrobial, antibacterial, antifungal, antifouling, antibiofouling, antiviral and/or antiparasitic properties.

Typically, the substrate surface may be functionalised by a range of different wet or dry (solventless) techniques, including, but not limited to: pulsed plasmachemical deposition; remote pulsed plasmachemical deposition; plasma enhanced chemical vapour deposition (PECVD); remote plasma enhanced chemical vapour deposition; initiated chemical vapour deposition (iCVD); atomised spray plasma deposition; plasma polymerization; electron/ion beam deposition; chemical vapour deposition (CVD); thermal chemical vapour deposition; liquid spray deposition; excited liquid spray deposition; photodeposition; ion-assisted deposition; electron beam polymerization; gamma-ray polymerization; or atomic layer deposition (ALD).

In a preferred embodiment, the substrate surface is functionalised by a dry (solventless) technique. Avoiding the use of wet techniques consequently removes the requirement for additional material such as solvent during the polymer layer deposition process.

In a preferred embodiment, the substrate surface may be functionalised via pulsed plasmachemical deposition.

Typically, polymer deposited on the substrate surface to functionalise the same is a polymer having an appropriate functional group or groups.

In one embodiment, said polymer layer is formed from aromatic ring-containing functional monomer precursors.

Typically, said polymer layer is formed from any functional monomer precursor from the group including: styrene, benzyl acrylate, vinylbenzaldehyde, vinylbenzyl chloride, perfluoroallylbenzene, pentafluorostyrene, vinylaniline, or vinylpyridine.

In one embodiment, said lubricant may be antimicrobial, antibacterial, antifungal, antifouling, antibiofouling, antiviral and/or antiparasitic.

Typically, said lubricant is provided in liquid form.

In some embodiments, said lubricant is selected from the group including: squalane; hexadecane 2-methyl-undecanal; 1-undecanol; decanal; geraniol; perfluorotributylamine; perfluoropolyether; perfluorodecalin; rapeseed oil; olive oil; vacuum pump oil; cinnamaldehyde; a cinnamaldehyde derivative, essential oil or an essential oil-derived compound.

In some embodiments, said lubricant may comprise a liquid plus solid mixture. Typically, said liquid plus solid mixture may comprise nanoparticles and/or nanosheets dispersed within a liquid.

In some embodiments, said lubricant may comprise a liquid plus bioactive agent mixture. Typically, said liquid plus bioactive agent mixture may comprise an antimicrobial substance dispersed within a liquid, for example, an antimicrobial metallosurfactant.

In one embodiment, where the polymer layer is formed from the polymerisation of perfluoroallylbenzene, said lubricant is selected from the group comprising perfluorotributylamine, perfluoropolyether or perfluorodecalin.

In one embodiment, where the polymer layer is formed from the polymerisation of benzyl acrylate, vinylbenzaldehyde, vinylbenzyl chloride or vinylaniline said lubricant is selected from the group comprising cinnamaldehyde, a cinnamaldehyde derivative, citral, decanal, 2-methyundecanal, hexadecane, polygodial, an essential oil or an essential oil-derived compound.

Typically, said cinnamaldehyde derivatives include 2-nitrocinnamaldehyde, 3,5-dimethoxy-4-hydroxycinnamaldehyde, 4-(diethylamino)cinnamaldehyde, 4-(dimethylamino)cinnamaldehyde, 4-acetoxy-3-methoxycinnamaldehyde, 4-bromocinnamaldehyde, 4-chlorocinnamaldehyde, 4-fluorocinnamaldehyde, 4-hydroxy-3-methoxycinnamaldehyde, 4-nitrocinnamaldehyde, o-methoxycinnamaldehyde, p-methoxycinnamaldehyde, supercinnamaldehyde, α-amylcinnamaldehyde, α-bromocinnamaldehyde, α-chlorocinnamaldehyde, α-hexylcinnamaldehyde, α-methylcinnamaldehyde, β-phenylcinnamaldehyde, or a derivative of any of these, or a mixture/combination thereof.

Typically, said essential oil may be selected from the group containing Agar oil or oodh, distilled from agarwood (Aquilaria malaccensis); Ajwain oil, from Carum copticum; Angelica root oil, from Angelica archangelica; Anise oil, Asafoetida oil, Balsam of Peru, Basil oil, Bay oil, Bergamot oil, Black pepper oil, Buchu oil, Birch oil, Camphor oil, Cannabis flower essential oil, Calamodin oil, Caraway seed oil, Cardamom seed oil, Carrot seed oil, Cedar oil (or cedarwood oil), Chamomile oil, Calamus oil, Cinnamon oil, Cistus ladanifer oil, Citron oil, Citronella oil, Clary Sage oil, Coconut oil, Clove oil, Coffee oil, Coriander oil, Costmary oil (bible leaf oil), Costus root oil, Cranberry seed oil, Cubeb oil, Cumin seed oil/black seed oil, Cypress oil, Cypriol oil, Curry leaf oil, Davana oil, Dill oil, Elecampane oil, Elemi oil, Eucalyptus oil, Fennel seed oil, Fenugreek oil, Fir oil, Frankincense oil, Galangal oil, Galbanum oil, Garlic oil, Geranium oil, Ginger oil, Goldenrod oil, Grapefruit oil, Henna oil, Helichrysum oil, Hickory nut oil, Horseradish oil, Hyssop oil, Tansy oil, Jasmine oil, Juniper berry oil, Laurus nobilis oil, Lavender oil, Ledum oil, Lemon oil, Lemongrass oil, Lime oil, Linseed oil, Litsea cubeba oil, Mandarin oil, Marjoram oil, Melissa oil (Lemon balm), Mentha arvensis oil (mint oil), Moringa oil, Mountain Savory oil, Mugwort oil, Mustard oil, Myrrh oil, Myrtle oil, Neem oil or neem tree oil, Neroli oil, Nutmeg oil, Orange oil, Oregano oil, Orris oil, Palo Santo oil, Parsley oil, Patchouli oil, Perilla oil, Pennyroyal oil, Peppermint oil, Petitgrain oil, Pine oil, Ravensara oil, Red Cedar oil, Roman Chamomile oil, Rose oil, Rosehip oil, Rosemary oil, Rosewood oil, Sage oil, Sandalwood oil, Sassafras oil, Savory oil from Satureja species, Schisandra oil, Spearmint oil, Spikenard oil, Spruce oil, Star anise oil, Tangerine oil, Tarragon oil, Tea tree oil, Thyme oil, Tsuga oil, Turmeric oil, Tung oil, Valerian oil, Warionia oil, Vetiver oil (khus oil). Western red cedar oil, Wintergreen oil, Yarrow oil, Ylang-ylang oil, or a mixture/combination thereof.

Typically, said essential oil-derived compounds may be selected from the group containing 3-carene, allyl isothiocyanate, anethole, berberine, borneol, camphene, carvacrol, carvacrol methyl ester, carvone, caryophyllene oxide, cedrol, cinnamaic acid, cis-hex-3-en-1-ol, citral, citronellal, citronellic acid, curcumin, eucalyptol, eugenol, farnesol, ferulic acid, geraniol, geranyl acetate, limonene, linalool, menthol, menthone, methyl salicylic acid, methyl salycilate, nerol, nerolidol, pinocarvone, polygodial, sabinene, terpinen-4-ol, terpineol, thujone, thymol, tropolone, verbenone, α-pinene, α-terpinene, α-terpineole, β-pinene, β-thujaplicin, or a derivative of any of these, or a mixture/combination thereof.

In one embodiment, said polymer coated substrate is immersed into a solution or liquid form of said lubricant for a period of approximately 15 minutes. Typically, said immersion is performed at a temperature of approximately 20° C.

In one embodiment, upon removal of said lubricant-infused surface from the solution/liquid, the surface is washed in pure, distilled and/or deionized water. Typically, said surface is washed for at least 5 minutes. Typically, said surface is shaken whilst being washed.

In one embodiment, the lubricant-infused surface is subsequently dried for at least 3 hours. Typically, said lubricant-infused surface is dried at a temperature of 20° C.

The present invention therefore provides a simple and quick two-step coating method comprising conformal pulsed plasma polymerisation of a variety of functional monomers onto solid substrates, followed by lubricant impregnation into the deposited functional polymer nanolayer to produce slippery lubricant-infused surfaces. The invention also provides for a one-step method in instances wherein the substrate surface itself is already functionalised, via the presence of aromatic ring-containing compounds, and so it may be treated directly with lubricant to form the slippery surface.

In another aspect of the present invention, there is provided a liquid repellent slippery surface, said surface comprising:
a substrate and associated substrate surface;
said substrate surface functionalised via the deposition of a polymer layer thereon; and
wherein said polymer layer is formed from a functional monomer precursor comprising a siloxane-group containing monomer or an alkyl-group containing monomer.

Typically, said monomer precursor is provided to be octamethylcyclotetrasiloxane (OMCTS).

Typically, said monomer precursor is provided to be hexyl acrylate.

In some embodiments, said liquid repellent slippery surface further includes a lubricant formed with said polymer layer.

Typically, said lubricant is formed concurrently (in situ) with said polymer layer.

Typically, said lubricant is provided to be a low molecular weight oligomer formed from the same monomer precursor which forms the polymer layer.

Typically, said liquid repellent slippery surface is defined as having a liquid contact angle hysteresis value of 10⁰ or less, and a liquid sliding angle of 10⁰ or less

Typically, said liquid repellent slippery surface is provided to have antifouling properties.

In some embodiments, said liquid repellent slippery surface may further include a lubricant impregnated into the polymer layer, further increasing the liquid repellent properties thereof.

Typically, said lubricant may be an oil. Preferably, said lubricant is silicone oil.

In another aspect of the present invention, there is provided a method of preparing a liquid repellent slippery surface, said method comprising the steps of:
providing a substrate having an associated substrate surface;
functionalising the surface of the substrate via the deposition of a polymer layer thereon;
wherein said polymer layer is formed from a functional monomer precursor comprising a siloxane-group containing monomer or an alkyl-group containing monomer.

In some embodiments, a lubricant formed with said polymer layer. Typically, said lubricant is generated concurrently (in situ) with said polymer layer from said functional monomer precursor.

Embodiments of the present invention will now be described with reference to the accompanying figures, wherein:

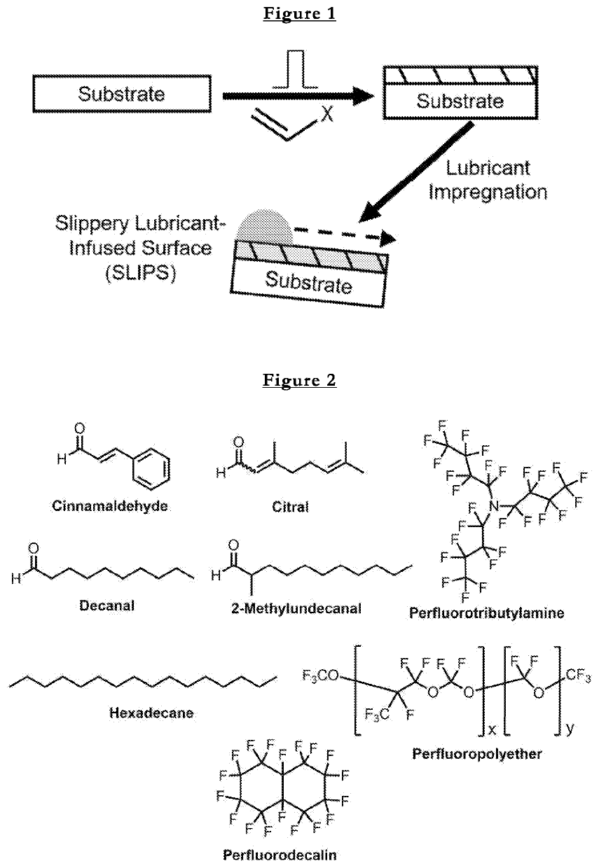

FIG. 1 illustrates a schematic of pulsed plasma deposited slippery lubricant-infused nanocoatings, in accordance with an embodiment of the present invention;

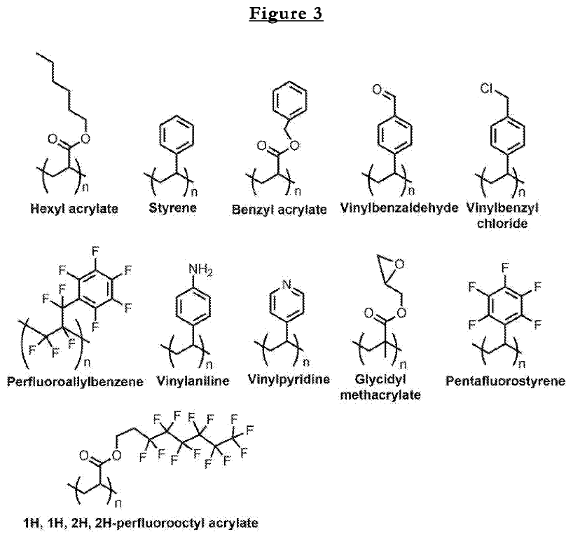

FIG. 2 illustrates chemical structures of examples of lubricants, in accordance with some embodiment of the present invention;

FIG. 3 illustrates chemical structures of functional monomers for pulsed plasma deposited nanolayers, in accordance with some embodiments of the present invention;

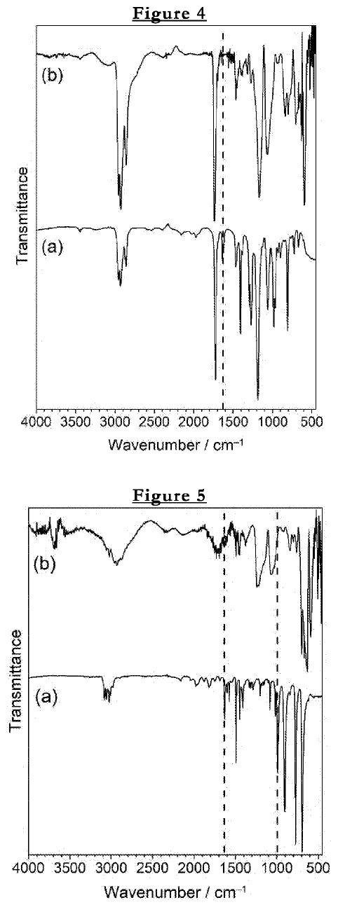

FIG. 4 illustrates infrared spectra of: (a) hexyl acrylate monomer (ATR); and (b) pulsed plasma poly(hexyl acrylate) deposited onto silicon wafer (RAIRS, 55°). Dashed line corresponds to acrylate carbon-carbon double bond feature (1638 cm⁻¹);

FIG. 5 illustrates infrared spectra of: (a) styrene monomer (ATR); and (b) pulsed plasma poly(styrene) deposited onto silicon wafer (RAIRS, 66°). Dashed lines correspond to vinyl group absorbances (1629 cm⁻¹ and 994 cm⁻¹);

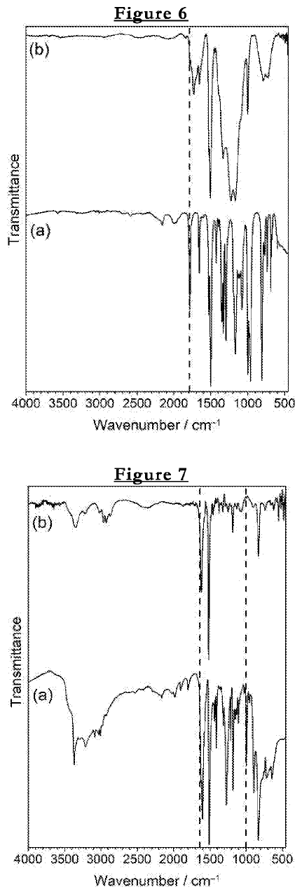

FIG. 6 illustrates infrared spectra of: (a) perfluoroallylbenzene monomer (ATR); and (b) pulsed plasma poly(perfluoroallylbenzene) deposited onto silicon wafer (RAIRS, 55°). Dashed line corresponds to allyl C═C stretch absorbance (1787 cm⁻¹);

FIG. 7 illustrates infrared spectra of: (a) vinylaniline monomer (ATR); and (b) pulsed plasma poly(vinylaniline) deposited onto silicon wafer (RAIRS, 66°). Dashed lines correspond to vinyl group absorbances (1622 cm⁻¹ and 994 cm⁻¹);

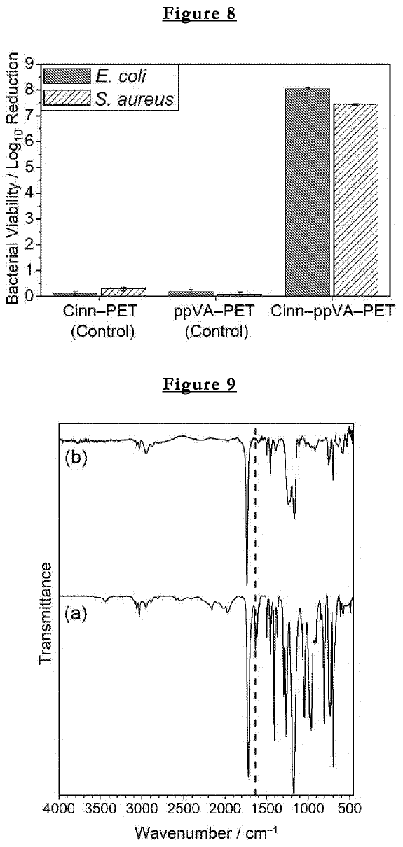

FIG. 8 illustrates E. coli and S. aureus antibacterial tests for cinnamaldehyde-only treated PET (control); pulsed plasma poly(vinylaniline) coated PET (control); and pulsed plasma poly(vinylaniline)-cinnamaldehyde lubricant infused coating on PET substrate. Values are mean Log₁₀ reductions relative to untreated PET substrates. Error bars represent ±standard deviation;

FIG. 9 illustrates infrared spectra of: (a) benzyl acrylate monomer (ATR); and (b) pulsed plasma poly(benzyl acrylate) on silicon wafer (RAIRS, 66°). Dashed line corresponds to acrylate C═C absorbance (1633 cm⁻¹);

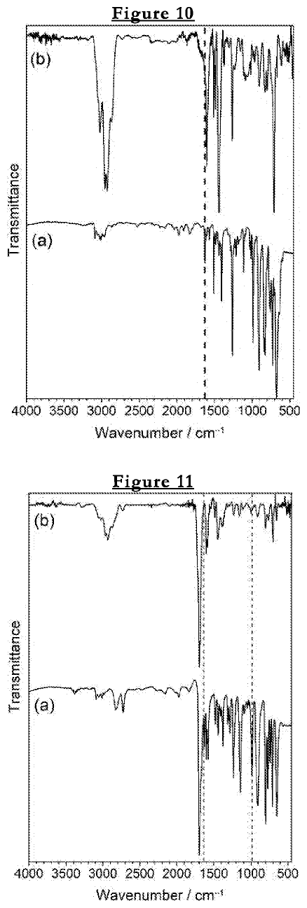

FIG. 10 illustrates infrared spectra of: (a) vinylbenzyl chloride monomer (ATR); and (b) pulsed plasma poly(vinylbenzyl chloride) on silicon wafer (RAIRS, 55°). Dashed line corresponds to vinyl group absorbance (1630 cm⁻¹);

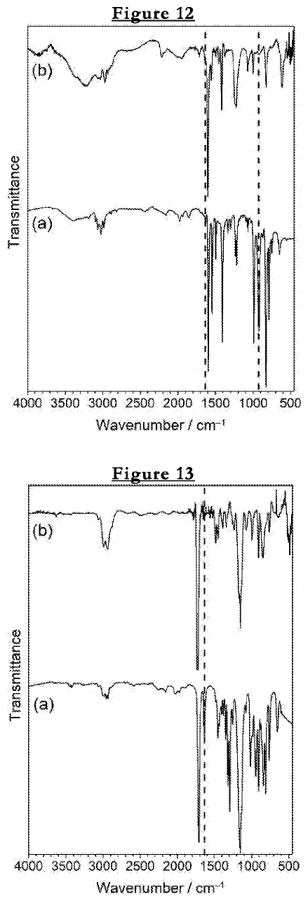

FIG. 11 illustrates infrared spectra of: (a) vinylbenzaldehyde monomer (ATR); and (b) pulsed plasma poly(vinylbenzaldehyde) on silicon wafer (RAIRS, 55°). Dashed lines correspond to vinyl group absorbances (1630 cm⁻¹);

FIG. 12 illustrates infrared spectra of: (a) vinylpyridine monomer (ATR); and (b) pulsed plasma poly(vinylpyridine) on silicon wafer (RAIRS, 55°). Dashed lines correspond to vinyl group absorbances (1633 cm⁻¹ and 922 cm⁻¹);

FIG. 13 illustrates infrared spectra of: (a) glycidyl methacrylate monomer (ATR); and (b) pulsed plasma poly(glycidyl methacrylate) on silicon wafer (RAIRS, 55°). Dashed line corresponds to acrylate C═C bond absorbance (1638 cm⁻¹);

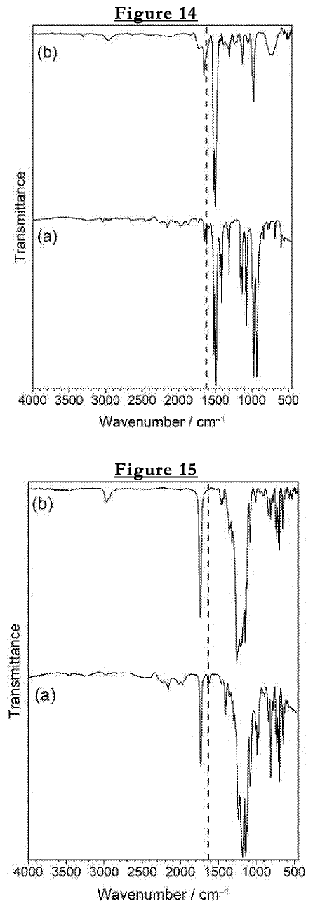

FIG. 14 illustrates infrared spectra of: (a) pentafluorostyrene monomer (ATR); and (b) pulsed plasma poly(pentafluorostyrene) on silicon wafer (RAIRS, 55°). Dashed line corresponds to vinyl C═C bond absorbance (1625 cm⁻¹);

FIG. 15 illustrates infrared spectra of: (a) 1H, 1H, 2H, 2H-perfluorootcyl acrylate monomer (ATR); and (b) pulsed plasma poly(1H, 1H, 2H, 2H-perfluorootcyl acrylate) on silicon wafer (RAIRS, 55°). Dashed line corresponds to acrylate C═C bond absorbance (1638 cm⁻¹);

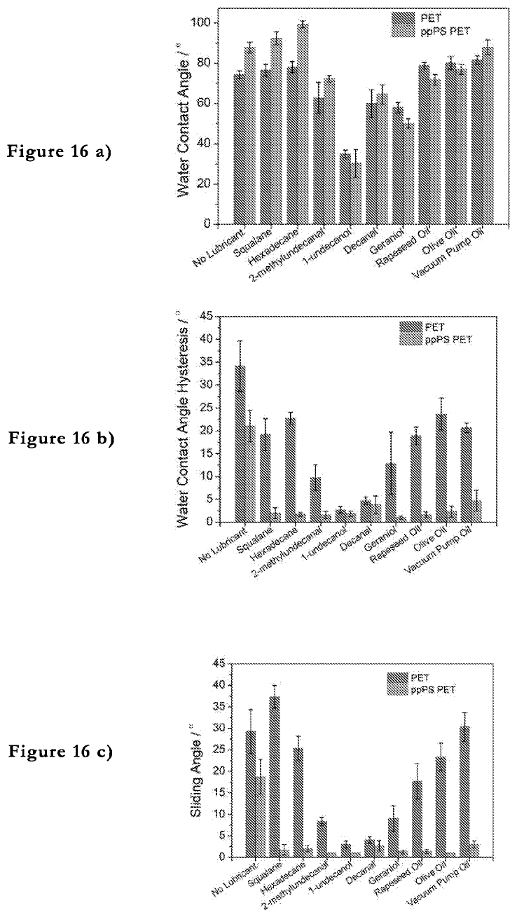

FIGS. 16a-c illustrate water repellency of PET and ppPS coated PET substrates when no lubricant is used and when infused with a variety of lubricants: (a) water contact angle values for 2 μL high purity water droplets; (b) water contact angle hysteresis values; and (c) sliding angle values for 50 μL high purity water droplets;

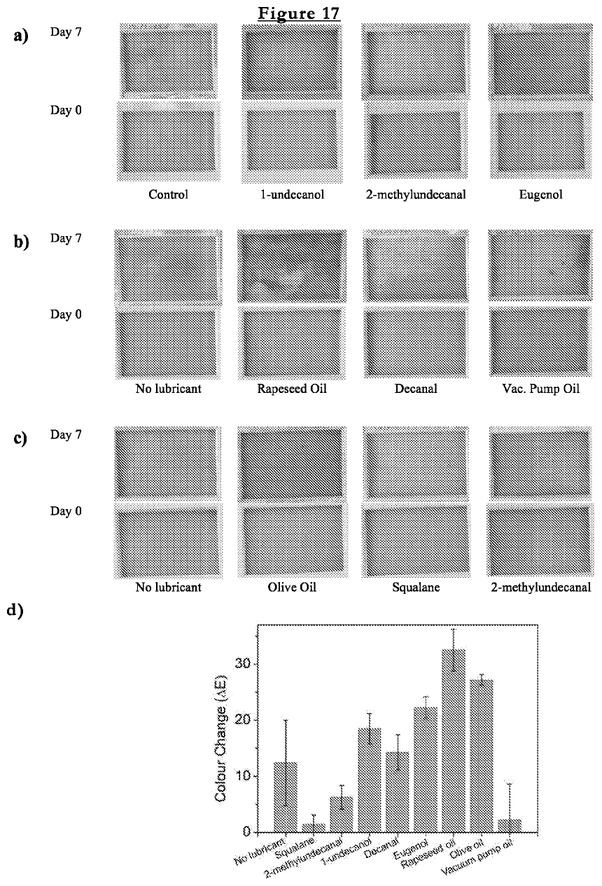

FIGS. 17a-d illustrate biofouling results using ppPS coated PET control and infused with various lubricants: (a) (1-undecanol, 2-methylundecanal and eugenol); (b) (rapeseed oil, decanal and vacuum pump oil); (c) (olive oil, squalane and 2-methylundecanal) showing photographs before and after 7 days of water immersion in the biofouling tank (water temperature: 5-10° C.); and (d) Measured colour change quantity value of ppPS control and infused with various lubricants (squalane, 2-methylundecanal, decanal, 1-undecanol, eugenol, rapeseed oil, olive oil, vacuum pump oil) after 7 days of immersion of in the biofouling tank (water temperature: 5-10° C.);

FIG. 18 illustrates contact angle, water contact angle hysteresis, and sliding angle values for ppPS coated PET control and infused with various lubricants (squalane, 2-methylundecanal, and vacuum pump oil) following 7 days of immersion in the biofouling tank (water temperature: 5-10° C.);

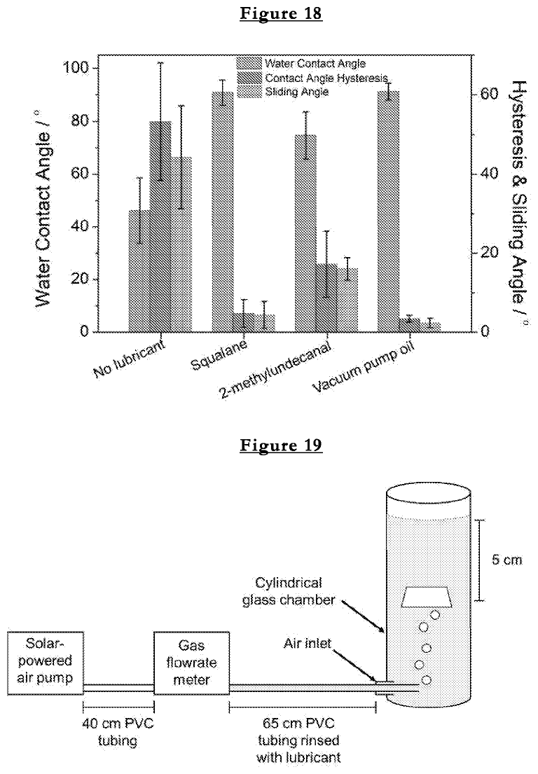

FIG. 19 illustrates an experimental set up for underwater lubricant infusion into ppPS coated PET. Lubricated tube is coloured brown, and bubbles carry lubricant onto suspended rectangular ppPS coated PET piece;

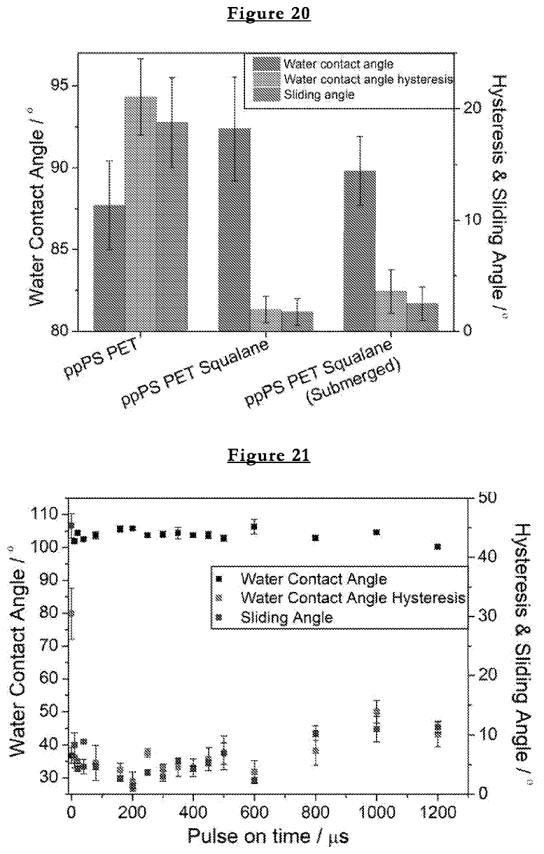

FIG. 20 illustrates water contact angle, water contact angle hysteresis and sliding angle values for ppPS coated PET, ppPS coated PET infused with squalane by neat lubricant immersion, and ppPS coated PET infused with squalane by air bubble transport whilst submerged;

FIG. 21 illustrates water contact angle, water contact angle hysteresis and sliding angle values for pulsed plasma deposition using OMCTS ppOMCTS coated glass microscope slides with various on times (off time=20 ms, deposition time=10 min); and

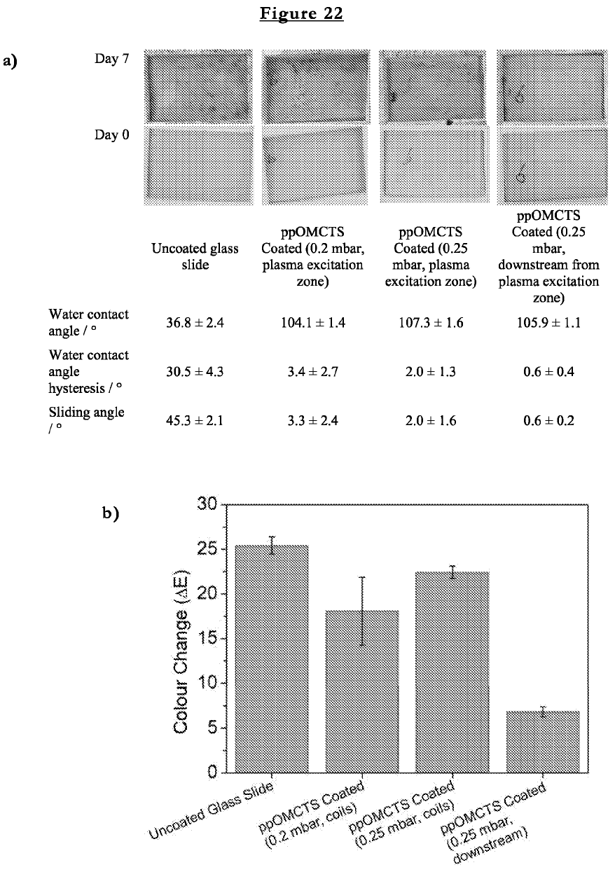

FIG. 22 illustrates colour change of results using glass microscope slides uncoated versus various pulsed plasma OMCTS coated (on time=200 μs, off time=20 ms, deposition time=30 min, peak power=40 W, plasma excitation zone and downstream from plasma excitation zone) before and after 7 days of immersion in a biofouling tank.

Referring firstly to FIG. 1 there is illustrated a general schematic of a simple and quick two-step coating method comprising conformal pulsed plasma polymerisation of a variety of functional monomers onto solid substrates, followed by lubricant impregnation into the deposited functional polymer nanolayer to produce slippery lubricant-infused surfaces.

Lubricants employed include: environmentally-friendly cinnamaldehyde (a major component of cinnamon tree bark oil—which displays potent broad-spectrum antibacterial activity, as well as antiviral, and antifungal efficacies); citral (present in the oils of lemon (Citrus limon), sweet orange (Citrus sinensis), and bergamot (Citrus bergamia)); decanal (contained in the oils of sweet orange (Citrus sinensis), coriander leaf (Coriandrum sativum L.), and Ducrosia anethifolia); and 2-methylundecanal (found in the essential oils extracted from members of the Rutaceae family, including kumquat (Fortunella margarita) peel oil, and Ruta graveolens). Cinnamaldehyde, citral, and decanal lubricants are all classified as generally recognised as safe (GRAS) by the US Food and Drug Administration, and 2-methylundecanal does not present a safety concern to human health according to the Joint FAO/WHO Expert Committee on Food Additives (JECFA). Other lubricants investigated include hexadecane (as a non-polar lubricant); and perfluorotributylamine, perfluoropolyether and perfluorodecalin (as fluorinated lubricants). A molecular level structure-behaviour relationship has been developed by comparing the liquid repellency between different combinations of pulsed plasma functional monomer and impregnated lubricant liquid, utilised for slippery surface fabrication.

### EXPERIMENTAL

### Pulsed Plasmachemical Deposition

A cylindrical glass reactor (5.5 cm diameter, 475 cm³ volume) housed within a Faraday cage was used for plasmachemical deposition. This was connected to a 30 L min⁻¹ rotary pump (model E2M2, Edwards Vacuum Ltd.) via a liquid nitrogen cold trap (base pressure less than 2×10⁻³ mbar and air leak rate better than 6×10−1 mol s⁻¹). A copper coil wound around the reactor (4 mm diameter, 10 turns, located 10 cm downstream from the gas inlet) was connected to a 13.56 MHz radio frequency (RF) power supply via an L-C matching network. A pulse signal generator was used to trigger the RF power supply. Prior to film deposition, the whole apparatus was thoroughly scrubbed using detergent and hot water, rinsed with propan-2-ol (+99.5 wt. %, Fisher Scientific UK Ltd.), oven dried at 150° C., and further cleaned using a 50 W continuous wave air plasma at 0.2 mbar for 30 min. Polyethylene terephthalate film (PET, capacitor grade, 0.10 mm thickness, Lawson-Mardon Ltd.) or non-woven porous polypropylene cloth (0.41 mm thick, 22.7±4.4 m fibre diameter, with dimpled structure 0.68±0.16 mm separation, spunbond, 70 g m⁻², Avoca Technical Ltd) was rinsed in absolute ethanol (+99.5%, Fisher Scientific UK Ltd.) for 15 min prior to insertion into the centre of the plasma chamber. Silicon wafer (Silicon Valley Microelectronics Inc., orientation: <100>, resistivity: 5-20 ohm-cm, thickness: 525±25 μm, front surface: polished, back surface: etched) cleaning comprised sonication in a 50:50 100 ml mixture of propan-2-ol and cyclohexane (+99.7 wt. %, Sigma-Aldrich Ltd.) for 15 min prior to air drying and placement into the centre of the chamber. Further cleaning entailed running a 50 W continuous wave air plasma at 0.2 mbar for 30 min. The monomer precursor was loaded into a sealable glass tube, degassed via several freeze-pump-thaw cycles, and then attached to the reactor. Monomer vapour was then allowed to purge the apparatus at a pressure of typically 0.15-0.20 mbar (except benzyl acrylate, which had a vapour pressure of 0.08 mbar) for 15 min prior to electrical discharge ignition. An initial continuous wave plasma was run for 30 s to ensure good adhesion to the substrate before switching to pulsed mode required for well-defined plasmachemical deposition over a period lasting 30 min. Upon electrical discharge extinction, the precursor vapour was allowed to continue to pass through the system for a further 15 min, and then the chamber was evacuated to base pressure followed by venting to atmosphere.

Monomers utilised for pulsed plasmachemical deposition were: styrene (>99%, Sigma-Aldrich Inc.), 4-vinylaniline (Fluorochem Ltd.), 3-vinylbenzladehyde (97%, Sigma-Aldrich Inc.), vinylbenzyl chloride (97%, mixture of 2-, 3- & 4-isomers, Sigma-Aldrich Inc.), vinylpyridine (95%, Sigma-Aldrich Inc.), butyl acrylate (>99%, Sigma-Aldrich Inc.), hexyl acrylate (98%, Sigma-Aldrich Inc.), isooctyl acrylate (>90%, Sigma-Aldrich Inc.), glycidyl methacrylate (97%, Sigma Aldrich), benzyl acrylate (97%, Alfa Aesar, Fisher Scientific UK Ltd.), pentafluorostyrene (Apollo Scientific Ltd.), perfluoroallylbenzene (Fluorochem Ltd.), and 1H, 1H, 2H, 2H-perfluorooctylacrylate (Fluorochem Ltd.).

### Polystyrene Surfaces

Polystyrene (pellets, average M, 280,000) was dissolved in chloroform (99.8+%, Fisher Scientific UK Ltd.) to give a 5% w/v solution. Glass slides (15 mm×15 mm) were cleaned ultrasonically in 100 ml of a 50:50 mixture of propan-2-ol and cyclohexane for 15 min and then dried. Several drops of the polystyrene solution were placed onto the glass slide so that the entire surface was covered. The solvent was allowed to evaporate under ambient conditions at 20° C. In addition, polystyrene petri dishes (Fisherbrand™ polystyrene Petri dishes, Fisher Scientific UK Ltd.) were cut into small pieces (15 mm×15 mm).

### Formation of Slippery Lubricant-Infused Surfaces

The lubricants used were: cinnamaldehyde (99%, Acros Organics brand, Fisher Scientific UK Ltd.), citral (95%, mixture of isomers, Acros Organics brand, Fisher Scientific UK Ltd.), decanal (>98%, Mystic Moments Madar Corporation Ltd.), 2-methylundecanal (>98%, Mystic Moments Madar Corporation Ltd.), hexadecane (99%, Sigma-Aldrich Inc.), perfluorodecalin (90%, mixture of cis and trans isomers, Acros Organics brand, Fisher Scientific UK Ltd.), perfluorotributylamine (Fluorinert FC-43, 3M Inc.), and perfluoropolyether (Fomblin® Y LVAC 06/6, Ausimont Ltd.).

Lubricant infused surfaces were prepared by immersing the coated substrate into several millilitres of the neat lubricant liquid at 20° C. for 15 min. Afterwards, the substrates were removed from solution, placed in deionised water and shaken for 5 min followed by removal and drying in air for at least 3 h at 20° C., with the samples stood upright to allow any excess lubricant to run off.

Control substrates were prepared by immersing untreated PET substrates into the lubricant and removing any excess lubricant as described above.

### Coating Characterization

Infrared spectra were acquired using a FTIR spectrometer equipped with a liquid nitrogen cooled MCT detector (model Spectrum One, PerkinElmer Inc.). Spectra were collected at 4 cm⁻¹ resolution across the 400-4000 cm⁻¹ range and averaged over 265 scans. Attenuated total reflectance (ATR) infrared spectra were obtained using a diamond ATR accessory (model Golden Gate, Graseby Specac Ltd.). Reflection-absorption (RAIRS) measurements utilized a variable angle accessory (Graseby Specac Ltd.) fitted with a KRS-5 polarizer (to remove the s-polarized component) set at either 55° or 66° with respect to the surface normal.

Coating thicknesses were measured using a spectrophotometer (model nkd-6000, Aquila Instruments Ltd.), Supporting Information Table. This entailed acquisition of transmittance-reflectance curves (350-1000 nm wavelength range) for each coated sample and fitting to a Cauchy model for dielectric materials using a modified Levenberg-Marquardt algorithm.

### Contact Angle Analysis

Sessile drop static contact angle measurements were carried out at 20° C. using a video capture apparatus in combination with a motorised syringe (model VCA 2500XE, A.S.T. Products Inc.). 2.0 μl droplets of ultrapure water were employed to assess hydrophobicity. Advancing and receding contact angle values were determined by respectively increasing the dispensed 2.0 μl liquid drop volume by a further 2.0 μl at a rate of 0.1 μl s⁻¹, and then decreasing the liquid drop volume at a rate of 0.1 μl s⁻¹. Measurements were repeated at least 3 times.

### Sliding Angle Analysis

Sliding angle measurements were carried out at 20° C. using a V-block adjustable angle gauge (model Adjustable Angle Gauge/Tilting Vee Blocks small, Arc Euro Trade Ltd.). Samples were placed onto the stage with an initial angle of 0°. A 50 μl droplet of deionised water was dispensed onto the sample, and the tilt angle was slowly increased at a rate of 1° every 5 s until movement of the water droplet was observed. Measurements were repeated at least 3 times.

Heptane (99%, Sigma-Aldrich Inc.), motor engine oil (GTX Magnatec 15W-40, Castrol Ltd.), and vacuum pump oil (white mineral oil (petroleum)) (Ultragrade Performance 19 Vacuum Oil, Edwards Vacuum Ltd.) were tested for the poly(perfluoroallylbenzene)-perfluoropolyether coating in the same way.

For longevity and regeneration testing, slippery lubricant-infused surfaces were prepared on PET film pieces as previously described. Samples were subsequently left to sit under ambient conditions for a period of 4-5 months. Samples were then qualitatively assessed for slippery behaviour by placing drops of deionised water onto the samples—if the droplets were found to easily slide off at low tilt angles, the sample was considered to be still slippery, whereas if the droplets were seen to not move, to only slide at high tilt angles, or to wet the sample, then the sample was considered to have lost its slippery behaviour. Samples which had lost their slippery behaviour during storage were regenerated by immersion in a few millilitres of the relevant neat lubricant liquid for 5 min, washing in deionised water with shaking for 5 min, followed by removal and drying in air for at least 3 h at 20° C. Samples were then tested for slippery behaviour as described earlier.

### Foodstuffs Repellency

Pulsed plasma poly(vinylaniline) was deposited onto the insides of glass vials. Slippery lubricant-infused surfaces were produced by filling these vials with either cinnamaldehyde, citral, decanal, or 2-methylundecanal. The vials were left to stand with the lids closed for 15 min. Next, the aldehyde liquid was discarded from the vials and the vials were upturned to dry with lids off for 15 min so that any excess unbound lubricant could run off. The vials were then rinsed twice with deionised water to help remove any remaining unbound lubricant, and subsequently upturned to dry for 15 min. Finally, the vials were turned upright and dried for a further 15 min before use. Uncoated glass vials were treated with aldehyde liquids in the same way to serve as controls.

Tomato ketchup and clear honey (Sainsbury's Supermarkets Ltd.) were used for repellency testing. Approximately a few millilitres of the foodstuff was dispensed into the glass vials. The vials were then upturned, and the behaviour of the foodstuffs recorded using a video camera.

### Antibacterial Testing

Gram-negative Escherichia coli BW25113 (CGSC 7636; rrnB3 ΔlacZ4787 hsdR514 Δ(araBAD)567 Δ(rhaBAD)568 rph-1) and Gram-positive Staphylococcus aureus (FDA209P, an MSSA strain; ATCC 6538P) bacteria cultures were prepared using autoclaved (Autoclave Vario 1528, Dixons Ltd.) Luria-Bertani broth media (LB; L3022, Sigma-Aldrich Ltd., 2% w/v in Milli-Q® grade water). A 5 ml bacterial culture was grown from a single colony for 16 h at 37° C., and then 50 μL used to inoculate a sterile polystyrene cuvette (Catalogue No. 67.742, Sarstedt AG) containing 1 mL of LB Broth. The cuvette was covered with Parafilm (Cole-Parmer Ltd.) and then placed inside a bacterial incubator shaker (model Stuart Orbital Incubator S1500, Cole-Parmer Ltd.) set at 37° C. and 120 rpm. An optical density OD₆₀₀ₙₘ=0.4 was verified using a UV-Vis spectrophotometer (model Jenway 6300, Cole-Parmer Ltd.) to obtain bacteria at the mid-log phase of growth.

Uncoated control samples were washed in absolute ethanol for 15 min and then dried under vacuum in order to make sure they were sterile and clean. Sterile microtubes (1.5 mL, Sarstedt AG) were loaded with the untreated, or coated substrates. Next, 100 μL of the prepared bacterial culture was pipetted onto each substrate placed aseptically inside a microtube so that the microorganisms could interact with one side of the surface. In practice, for non-porous substrates the liquid spread over the whole area of the sample. The microtube lid was closed, to prevent the sample drying out, and the tube placed horizontally on a sample tray and incubated (model Bacterial Incubator 250, LMS Ltd.) without shaking for 4 h at 30° C. Next, 900 μL of autoclaved Luria-Bertani broth media was pipetted into each microtube and vortexed (model Vortex-Genie 2, Scientific Industries Inc.) in order to recover the bacteria as a 10-fold dilution (10⁻¹). Further ten-fold serial dilutions were undertaken to provide 10⁻², 10⁻³, 10⁻⁴, 10⁻⁵ and 10⁻⁶ samples. Colony-forming unit (CFU) plate counting was performed by placing 10 L drops from each diluted sample (10⁻¹ to 10⁻⁶ dilutions) onto autoclaved Luria-Bertani Agar solid plates (EZMix™ powder, dust free, fast dissolving fermentation medium, L7533, Sigma-Aldrich Ltd.) and incubated (model Bacterial Incubator 250, LMS Ltd.) for 16 h at 30° C. The number of colonies visible at each dilution were then counted. All tests were performed in triplicate. The Log₁₀ Reduction value for a treated sample was calculated relative to a control untreated sample. For each experiment, treated and untreated substrates were exposed to bacteria in parallel and incubated under identical conditions for the same time period before recovery and viability measurement. This test method to quantify the number of bacteria killed following exposure to treated substrates was chosen because cinnamaldehyde is not readily soluble in aqueous media and therefore its efficacy will be localised at the functionalised substrate surface which promotes compatibility with cinnamaldehyde. The high numbers of bacteria recovered from untreated substrates provides good evidence that the method is effective. Furthermore, the vortex mixer agitates the samples at 2000-3000 rpm and is fully capable of removing bacteria from surfaces.

For antibacterial recycling tests the same procedure as described above was followed, with the variation that, following 4 h incubation, the substrates were taken out from the 10⁻¹ dilution solution microtubes, rinsed with ultrapure water (approximately 50 ml) for 1 min at 20° C. and then completely air-dried overnight before the next use. Consecutive repeat tests were performed using the same samples, with the mid-log bacterial culture being placed on the same side of the substrate each time. All tests were performed in triplicate.

### Results

### Control Studies

Water contact angle hysteresis and sliding angle values for uncoated PET film substrate and following treatment with each of the lubricants were all measured to be relatively large in magnitude, see Tables 1 and 2 below.

TABLE 1
Water droplet static, advancing, receding, and hysteresis contact angle values, and water droplet sliding
angle values, for coated PET film substrates. Values are reported as mean ± standard deviation.

| | Contact Angle/° | | | | Sliding |
|---|---|---|---|---|---|
| Surface | Static | Advancing | Receding | Hysteresis | Angle/° |
| PET Untreated | 66.8 ± 1.6 | 76 ± 2 | 24 ± 3 | 52 ± 4 | 48 ± 2 |
| Pulsed Plasma Poly(hexyl acrylate) | 82.2 ± 0.8 | 86.2 ± 0.3 | 77.7 ± 1.0 | 8.5 ± 1.1 | 10.7 ± 0.5 |
| (ppHA) | | | | | |
| ppHA H₂O Washed | 80.9 ± 0.7 | 86.6 ± 0.8 | 76 ± 2 | 10 ± 2 | 9.3 ± 0.5 |
| Pulsed Plasma Poly(butyl acrylate) | 67.8 ± 1.9 | 76 ± 3 | 32 ± 3 | 44 ± 4 | 37 ± 1 |
| Pulsed Plasma Poly(iso-octyl acrylate) | 98.7 ± 0.4 | 101.7 ± 1.2 | 70 ± 4 | 31 ± 4 | 36 ± 0 |
| Pulsed Plasma Poly(styrene) (ppPS) | 79 ± 2 | 88 ± 5 | 60 ± 8 | 29 ± 10 | 37 ± 1 |
| ppPS-Decanal | 82.5 ± 0.7 | 87.5 ± 0.4 | 78 ± 7 | 9 ± 7 | 1.3 ± 0.2 |
| ppPS-2-Methylundecanal | 68.8 ± 1.6 | 69 ± 2 | 66.2 ± 1.8 | 3 ± 3 | 1.7 ± 0.2 |
| ppPS-Hexadecane | 98.6 ± 0.4 | 99.1 ± 0.4 | 98.3 ± 0.3 | 0.8 ± 0.5 | 1.0 ± 0.0 |
| ppPS-Cinnamaldehyde | 89 ± 4 | 97 ± 4 | 60 ± 10 | 37 ± 11 | 39 ± 1 |
| Drop-Cast Poly(styrene) (dcPS) | 90.3 ± 1.0 | 94.6 ± 1.1 | 74 ± 3 | 20 ± 3 | 14 ± 1 |
| dcPS-Hexadecane | 87.9 ± 1.0 | 94 ± 2 | 89 ± 3 | 5 ± 3 | 3 ± 1 |
| Petri Dish Poly(styrene) (pdPS) | 88.8 ± 1.1 | 95.0 ± 0.8 | 65 ± 2 | 30 ± 2 | 25 ± 1 |
| pdPS-Hexadecane | 94.7 ± 0.5 | 92.7 ± 1.4 | 87 ± 2 | 6 ± 3 | 6.7 ± 0.5 |
| pdPS-Cinnamaldehyde † | — | — | — | — | — |
| Pulsed Plasma Poly(benzyl acrylate) | 72.4 ± 0.6 | 83.5 ± 0.3 | 54 ± 2 | 30 ± 2 | 37.7 ± 0.5 |
| (ppBA) | | | | | |
| ppBA-Decanal | 56.1 ± 0.5 | 56 ± 3 | 54 ± 3 | 2 ± 4 | 2.7 ± 0.5 |
| ppBA-2-Methylundecanal | 66 ± 1 | 68.8 ± 0.2 | 68.3 ± 0.4 | 0.5 ± 0.4 | 2 ± 0 |
| ppBA-Hexadecane | 85 ± 2 | 84.0 ± 0.8 | 63 ± 2 | 21 ± 2 | 14 ± 0 |
| ppBA-Cinnamaldehyde | 60 ± 2 | 56 ± 3 | 52 ± 3 | 4 ± 4 | 3.3 ± 0.5 |
| Pulsed Plasma Poly(vinylbenzaldehyde) | 70.2 ± 1.5 | 80 ± 2 | 42 ± 8 | 38 ± 8 | 44 ± 1 |
| (ppVBA) | | | | | |
| ppVBA-Decanal | 35.3 ± 0.7 | 64.0 ± 0.4 | 58.1 ± 1.2 | 5.9 ± 1.2 | 4 ± 1 |
| ppVBA-2-Methylundecanal | 67.6 ± 0.1 | 68.6 ± 1.5 | 66.0 ± 0.4 | 2.6 ± 1.6 | 1.7 ± 0.2 |
| ppVBA-Hexadecane | 74 ± 2 | 73 ± 2 | 72.1 ± 0.8 | 1 ± 2 | 17 ± 1 |
| ppVBA-Cinnamaldehyde | 58 ± 3 | 59.4 ± 1.0 | 57.1 ± 0.6 | 2.3 ± 1.2 | 13 ± 1 |
| Pulsed Plasma Poly(vinylbenzyl chloride) | 84.4 ± 0.5 | 90.3 ± 1.9 | 72.5 ± 1.4 | 18 ± 2 | 14 ± 1 |
| (ppVBC) | | | | | |
| ppVBC-Decanal | 54 ± 3 | 53 ± 3 | 50 ± 3 | 3 ± 4 | 6.8 ± 0.2 |
| ppVBC-2-Methylundecanal | 67 ± 2 | 67 ± 3 | 67 ± 3 | 1 ± 4 | 1 ± 0 |
| ppVBC-Hexadecane | 81 ± 3 | 81 ± 2 | 79 ± 2 | 2 ± 3 | 15 ± 1 |
| ppVBC-Cinnamaldehyde | 67 ± 3 | 66 ± 3 | 56.3 ± 0.3 | 9 ± 3 | 27 ± 1 |
| Pulsed Plasma | 97 ± 2 | 107.1 ± 1.2 | 84 ± 4 | 23 ± 4 | 30 ± 1 |
| Poly(perfluoroallylbenzene) (ppPFAB) | | | | | |
| ppPFAB-Perfluorotributylamine | 118.4 ± 0.4 | 114.7 ± 0.7 | 112.1 ± 0.5 | 2.6 ± 0.9 | 2.7 ± 0.5 |
| ppPFAB-Perfluoropolyether | 109 ± 3 | 98.9 ± 1.5 | 95 ± 4 | 3.8 ± 3.8 | 1.7 ± 0.2 |
| ppPFAB-Perfluorodecalin | 119.1 ± 0.5 | 122.4 ± 0.4 | 104 ± 5 | 18 ± 5 | 9 ± 1 |
| Pulsed Plasma Poly(vinylaniline) (ppVA) | 75 ± 6 | 89.3 ± 0.7 | 23 ± 3 | 66 ± 3 | 90 (*) |
| ppVA-Decanal | 72.6 ± 0.9 | 75.4 ± 1.3 | 70.8 ± 1.0 | 4.6 ± 1.6 | 13 ± 1 |
| ppVA-2-Methylundecanal | 80.0 ± 1.4 | 82.8 ± 0.5 | 74.0 ± 1.2 | 8.8 ± 1.3 | 14 ± 2 |
| ppVA-Hexadecane | 75.4 ± 0.3 | 77.6 ± 0.8 | 72.3 ± 1.4 | 5.3 ± 1.6 | 17 ± 1 |
| ppVA-Cinnamaldehyde | 56.6 ± 0.1 | 57.9 ± 0.4 | 55.1 ± 0.9 | 2.8 ± 1.0 | 10 ± 1 |
| ppVA-Citral | 67.3 ± 0.6 | 69.6 ± 0.1 | 67.9 ± 0.2 | 1.7 ± 0.3 | 12 ± 2 |

(*) Water droplet showed no movement at 90° inclination of substrate from the horizontal.
† Cinnamaldehyde dissolves poly(styrene), and so it is not possible to make slippery surfaces for this combination.

TABLE 2
Water droplet static, advancing, receding, and hysteresis water contact angle
values and water droplet sliding angle values following lubricant treatment
of uncoated PET substrates. Values are reported as mean ± standard deviation.

| | Contact Angle / ° | | | | Sliding |
|---|---|---|---|---|---|
| Surface | Static | Advancing | Receding | Hysteresis | Angle / ° |
| PET | 66.8 ± 1.6 | 76 ± 2 | 24 ± 3 | 52 ± 4 | 48 ± 2 |
| PET-Cinnamaldehyde | 71 ± 4 | 76.8 ± 1.9 | 37 ± 4 | 40 ± 4 | 27.3 ± 0.5 |
| PET-Citral | 64 ± 3 | 67.0 ± 0.6 | 21 ± 4 | 46 ± 4 | 29 ± 1 |
| PET-Decanal | 71.9 ± 1.6 | 77 ± 2 | 49 ± 5 | 29 ± 6 | 10.3 ± 0.5 |
| PET-2- | 65 ± 3 | 68.8 ± 1.3 | 49.0 ± 0.7 | 20 ± 1.5 | 10.0 ± 0 |
| Methylundecanal | | | | | |
| PET-Hexadecane | 67 ± 4 | 73 ± 3 | 53 ± 3 | 20 ± 4 | 24.7 ± 1.7 |
| PET- | 114 ± 2 | 116.0 ± 1.9 | 63 ± 3 | 53 ± 3 | 29 ± 2 |
| Perfluorotributy lamine | | | | | |
| PET- | 82 ± 6 | 90 ± 4 | 32 ± 6 | 58 ± 8 | 41.0 ± 1.6 |
| Perfluoropolyether | | | | | |
| PET-Perfluorodecalin | 100 ± 5 | 105 ± 4 | 24 ± 4 | 81 ± 5 | 57 ± 2 |

Pulsed plasma deposition covering a range of functional monomers, illustrated in FIG. 3, was undertaken to provide a variety of well-adhered conformal host layers for lubricant impregnation. See Table 3, below. In the case of pulsed plasma deposited poly(vinylpyridine), poly(glycidyl methacrylate), poly(pentafluorostyrene), and poly(1H, 1H, 2H, 2H, perfluorooctyl acrylate), all were found to produce non-slippery surfaces when treated with the selection of test lubricants, discussed in more detail below.

TABLE 3
Pulsed plasma deposition parameters for deposited polymer
coatings, film thicknesses and deposition rates.

| | Peak | | | Deposition | Film | Deposition |
|---|---|---|---|---|---|---|
| | Power/ | tₒₙ/ | t_{off}/ | Temperature/ | Thickness/ | Rate/ |
| Monomer | W | μs | ms | ° C. | nm | nm min⁻¹ |
| Styrene | 30 | 100 | 4 | 20 | 200 | 6.7 |
| Hexyl acrylate | 40 | 20 | 20 | 20 | 373 | 12.4 |
| Benzyl acrylate | 40 | 20 | 20 | 20 | 168 | 5.6 |
| Vinylaniline | 40 | 100 | 4 | 40 | 177 | 5.9 |
| Vinylbenzaldehyde | 30 | 100 | 4 | 20 | 1242 | 41.4 |
| Vinylbenzyl chloride | 30 | 100 | 4 | 20 | 1774 | 59.1 |
| Vinylpyridine | 40 | 100 | 4 | 20 | 341 | 11.4 |
| Glycidyl methacrylate | 40 | 20 | 20 | 20 | 304 | 10.1 |
| Perfluoroallylbenzene | 40 | 100 | 4 | 20 | 1363 | 45.4 |
| Pentafluorostyrene | 30 | 100 | 4 | 20 | 1558 | 51.9 |
| 1H,1H,2H,2H- | 40 | 20 | 20 | 20 | 1214 | 40.5 |
| Perfluorootcyl acrylate | | | | | | |

### Pulsed Plasma Poly(Alkyl Acrylates)

Hexyl acrylate monomer displays the following characteristic infrared absorption bands: C—H stretching (3000-2830 cm⁻¹), acrylate carbonyl C═O stretching (1724 cm⁻¹), acrylate C═C stretching (1638 cm⁻¹ and 1631 cm⁻¹), and the C—O ester stretch (1182 cm⁻¹), see FIG. 4. Pulsed plasma deposited poly(hexyl acrylate) shows loss of the acrylate carbon-carbon double bond infrared absorbance features, thereby confirming that polymerisation had taken place.

It was found in the case of pulsed plasma polymerised hexyl acrylate coatings that there was no need for impregnation with lubricants, owing to the fact that the poly(hexyl acrylate)-only coating exhibited slippery behaviour with relatively low water contact angle hysteresis (<10°) and sliding angle (˜10°) values, see Table 1. None of the lubricant liquids tested significantly lowered the water contact angle hysteresis value, see Table 4, below.

TABLE 4
Water droplet static, advancing, receding, and hysteresis
contact angle values following lubricant impregnation of
pulsed plasma poly(hexyl acrylate) (ppHA) coated PET substrates.
Values are reported as mean ± standard deviation.

| | Contact Angle / ° | | | |
|---|---|---|---|---|
| Surface | Static | Advancing | Receding | Hysteresis |
| ppHA-Cinnamaldehyde | 71 ± 5 | 74 ± 6 | 58 ± 6 | 17 ± 9 |
| pp HA-Decanal | 83 ± 5 | 87 ± 4 | 79 ± 3 | 8 ± 5 |
| ppHA-2-Methyl- | 73.8 ± 0.5 | 76.1 ± 0.5 | 70.2 ± 1.4 | 5.9 ± 1.5 |
| undecanal | | | | |
| pp HA-Hexadecane | 91.6 ± 1.0 | 92.6 ± 1.5 | 81.2 ± 0.5 | 11.4 ± 1.5 |
| pp HA-Fluorinert | 83 ± 3 | 90.6 ± 1.1 | 78 ± 6 | 13 ± 6 |

In order to disprove that the low contact angle hysteresis of the poly(hexyl acrylate) coating might be due to loose low molecular weight material present on the surface (self-generated lubricant making the coating slippery), poly(hexyl acrylate) coated PET film was fully submerged into deionised water at 20° C. for 24 h, then removed and dried. The water contact angle hysteresis and the sliding angle values had not changed (within error), Table 1.

For the same electrical discharge parameters employed, pulsed plasma deposited poly(butyl acrylate) and poly(iso-octyl acrylate) nanolayers were not found to be slippery (i.e. exhibited high water contact angle hysteresis and sliding angles).

### Pulsed Plasma Poly(Styrene)

Liquid styrene monomer exhibits the following characteristic infrared absorption bands: C—H stretching (3100-2965 cm⁻¹), aromatic ring summations (2000-1700 cm⁻¹), vinyl C═C stretch (1629 cm⁻¹), aromatic C═C stretching (1600 cm⁻¹, 1574 cm⁻¹, 1494 cm⁻¹, and 1448 cm⁻¹), CH₂ deformations (1412 cm⁻¹), HC═CH trans wag (994 cm⁻¹), and ═CH₂ wag (906 cm⁻¹), see FIG. 5. The vinyl group bands were absent in the deposited pulsed plasma poly(styrene) infrared spectrum, indicating that polymerisation has taken place. Whilst aromatic ring features are still present, thereby confirming structural retention of the phenyl rings.

Pulsed plasma deposited poly(styrene) on PET substrate displays a large water contact angle hysteresis, Table 1. Whereas a slippery surface was obtained following decanal, 2-methylundecanal, or hexadecane impregnation into the pulsed plasma poly(styrene) coating. Hexadecane lubricant in particular gave excellent water-repellent properties, with both contact angle hysteresis and sliding angle values measured to be ≥1°. Cinnamaldehyde and perfluorotributylamine lubricants did not form a slippery surface when combined with the poly(styrene) coating.

In order to determine whether this approach for making slippery lubricant-infused surfaces could be extended beyond pulsed plasma deposited poly(styrene) coatings, conventional poly(styrene) coatings were drop-cast onto glass slides and treated with hexadecane lubricant. This led to a significant reduction of both the water contact angle hysteresis and the sliding angle values (≤5°), thereby demonstrating that the drop-cast poly(styrene) films also form slippery lubricant-infused surfaces, Table 1. Pre-formed poly(styrene) pieces cut from Petri dishes and then treated with hexadecane behaved in a similar fashion. Henceforth, a range of aromatic ring containing pulsed plasma polymer coatings were investigated and also shown to provide slippery surfaces following impregnation with lubricants—these included pulsed plasma deposited poly(benzyl acrylate), poly(vinylbenzaldehyde), poly(vinylbenzyl chloride), poly(perfluoroallylbenzene), and poly(vinylaniline).

### Pulsed Plasma Poly(Perfluoroallylbenzene)

Perfluoroallylbenzene monomer displays the following characteristic infrared absorption bands: allyl C═C stretch (1787 cm⁻¹), aromatic C—C stretching (1657 cm⁻¹, 1528 cm⁻¹, and 1502 cm⁻¹). It is difficult to unambiguously assign features in the spectral region below 1400 cm⁻¹, but peaks in this region are typically characteristic of C—F stretching vibrational modes, see FIG. 6. Following pulsed plasma deposition, the allyl bond diminished in intensity which is consistent with polymerisation taking place. Retention of the aromatic stretching bands in the pulsed plasma deposited layer confirms structural retention of the perfluorinated phenyl rings in the coating.

Pulsed plasma poly(perfluoroallylbenzene)-only coating did not display low water contact angle hysteresis values, Table 1. Both perfluorotributylamine and perfluoropolyether infused surfaces yielded coatings with low water contact angle hysteresis and sliding angle values (<5°). The perfluorotributylamine-infused surface was able to resist wetting by heptane (surface tension=20.14 mN m⁻¹). The perfluoropolyether-infused surface coating was able to resist wetting by pentane (surface tension=15.8 mN m⁻¹). For the latter, heptane slides at low angles (<17±1°), while vacuum pump oil and engine oil both slid off at very low angles (2.3±0.2° and 2.2±0.2° respectively). For the case of perfluorodecalin infused surface, both the water contact angle hysteresis and sliding angle values were lowered.

### Pulsed Plasma Poly(Vinylaniline)

The characteristic infrared bands of vinylaniline monomer can be assigned as follows: asymmetric amine stretch (3440 cm⁻¹), symmetric amine stretch (3370 cm⁻¹), aromatic C—H stretch (3100-3000 cm⁻¹), ring summations (2000-1750 cm⁻¹), vinyl C═C stretch (1622 cm⁻¹), NH₂ deformations (1610 cm⁻¹), para-substituted aromatic ring stretch (1513 cm⁻¹), ═CH₂ deformations (1412 cm⁻¹), aromatic C—N stretch (1314 cm⁻¹), para-substituted benzene ring stretch (1177 cm⁻¹), HC═CH trans wag (994 cm⁻¹), ═CH₂ wag (893 cm⁻¹), and —NH₂ wag (830 cm⁻¹), see FIG. 7. Pulsed plasma deposited poly(vinylaniline) shows similar infrared absorption bands, apart from the disappearance of the vinyl C═C group features (1622 cm⁻¹ and 994 cm⁻¹) and the appearance of an aliphatic C—H stretch (2865 cm⁻¹) confirming that polymerisation has taken place.

Pulsed plasma poly(vinylaniline)-coated PET substrates display large water contact angle hysteresis and sliding angle values (water droplet showed no movement at 900 inclination of the substrate from the horizontal), Table 1. Following impregnation with decanal, 2-methylundecanal, hexadecane, cinnamaldehyde, or citral lubricants, low water contact angle hysteresis and sliding angle values were measured. The citral-infused surface gave rise to the lowest water contact angle hysteresis value (1.7±0.3°), and cinnamaldehyde-infused surface produced the lowest water sliding angle (10±1°). The slippery behaviour displayed by the hexadecane-infused surface indicates that the pulsed plasma poly(vinylaniline) coating is also compatible with non-polar lubricants. Perfluorotributylamine did not form a slippery surface when combined with the pulsed plasma poly(vinylaniline) coating.

Decanal, 2-methylundecanal, cinnamaldehyde, and citral, lubricant-infused surfaces were left to stand for 4 months under ambient open-air laboratory conditions. Decanal and 2-methylundecanal lubricant-infused surfaces continued to display slippery behaviour after this 4-month storage period. It was found that the cinnamaldehyde and citral lubricant-infused surfaces no longer showed any slippery behaviour towards water droplets (probably due to essential oil evaporation). However, these slippery surfaces could easily be regenerated by immersion for 5 min in the corresponding essential oil. Less volatile essential oil molecules should give rise to even longer shelf-lives for these lubricant-impregnated surfaces.

The coatings' slippery performance was further tested using real-world foodstuffs. Tomato ketchup filled into an untreated glass vial showed no movement at all during gentle shaking, and when the vial was inverted, some of the ketchup fell out but much of it remained stuck to the insides of the vial. Control uncoated glass vials were also rinsed with just the lubricant aldehydes (decanal, 2-methylundecanal cinnamaldehyde, and citral). For the decanal control vial, some very slow ketchup movement was observed over the course of 50 s. Shaking the vial removed some ketchup, although much still remained. No ketchup movement was observed for the 2-methylundecanal control vial, and shaking the vial left much ketchup stuck to the walls of the vial. Cinnamaldehyde and citral control vials showed increased ketchup movement compared to the untreated vial, with some ketchup sliding out of the vial without any need to shake it. However, there remained ketchup in the vial which stopped moving after approximately 30 s.

For decanal, 2-methylundecanal, and cinnamaldehyde infused pulsed plasma poly(vinylaniline) coated glass vial surfaces, the ketchup readily slid out of the vial as soon as it was flipped over, with all the ketchup having left the vial in about 5 s. For citral-infused coating, the ketchup remained in place for approximately 5 s after the vial was upturned, and then started to slide out. Most of the ketchup left the vial, but some was still visible on the side.

In the case of honey placed into an untreated glass vial, the honey started to run slowly down the wall of the vial over the course of a minute or so, and several drops exited the vial. The rate at which the honey subsequently came out slowed down, and a relatively large amount of content was left behind attached to the bottom and sides of the vial. Similarly, for honey placed into the aldehyde lubricant rinsed control glass vials (decanal, 2-methylundecanal cinnamaldehyde, and citral), the honey flowed slowly with a significant amount remaining behind. The movement of honey in the vials coated with lubricant-infused pulsed plasma poly(vinylaniline) surfaces (decanal, 2-methylundecanal, cinnamaldehyde, and citral) was significant, leading to the majority of the honey leaving the vials (with the exception of a few small droplets) over the same timeframe as the controls.

### Antibacterial Testing

Cinnamaldehyde-infused pulsed plasma poly(vinylaniline) coated PET film surfaces were tested for antibacterial activities against Gram-negative E. coli and Gram-positive S. aureus, see FIG. 8, Table 5 below. PET substrates rinsed in cinnamaldehyde-only or coated with pulsed plasma poly(vinylaniline) showed a very small effect against E. coli and S. aureus bacteria (Log₁₀ Reduction<1). This could be due to a small residual amount of cinnamaldehyde remaining on the surface after washing and drying. Whilst the pulsed plasma poly(vinylaniline)-cinnamaldehyde coated PET substrates displayed strong antibacterial activity, giving rise to complete killing of both bacteria (Log₁₀ Reduction>7).

TABLE 5
Antibacterial tests for PET coated with pulsed plasma poly(vinylaniline)-
cinnamaldehyde. Log reduction values are relative to the untreated
substrate (average ± standard deviation).

| | Log10 Reduction | |
|---|---|---|
| Coating | E. coli | S. aureus |
| Cinnamaldehyde-only † | 0.12 ± 0.07 | 0.29 ± 0.07 |
| Poly(vinylaniline)-only † | 0.19 ± 0.08 | 0.08 ± 0.09 |
| Poly(vinylaniline)-Cinnamaldehyde Infused | 8.04 ± 0.04 | 7.44 ± 0.03 |

Recycle testing of pulsed plasma poly(vinylaniline)-cinnamaldehyde lubricant infused surfaces against E. coli showed complete loss of activity on the second test (Log₁₀ Reduction (E. coli)=0±0), confirming that the antibacterial mechanism corresponds to cinnamaldehyde release out from the surface. Recharging the samples by repeating immersion into cinnamaldehyde again led to the complete killing of the E. coli (Log₁₀ Reduction (E. coli)=8.06±0.03), thereby demonstrating that the coating could be easily regenerated and reused multiple times.

### Porous Substrate

Pulsed plasma poly(vinylaniline) was coated onto non-woven porous polypropylene cloth, impregnated with cinnamaldehyde, and the water sliding angle values were measured (N.B. due to the dimpled surface structure of the cloth, accurate static contact angle and contact angle hysteresis values could not be measured. Therefore, only water sliding angle values are reported here), see Table 6 below. The untreated polypropylene cloth does not show a slippery surface. After impregnation with cinnamaldehyde lubricant, the polypropylene cloth showed complete absorption/wetting by water droplets—this is likely due to the cinnamaldehyde displacing the trapped air layer in the cloth, allowing water to wick through the porous structure, but not forming a thin lubricant layer at the surface, meaning the substrate does not repel water. The pulsed plasma poly(vinylaniline) coated polypropylene cloth exhibited a very large water sliding angle, consistent with the same coating on non-porous PET. After impregnation with cinnamaldehyde lubricant, the coating formed a slippery surface, with the water sliding angle comparable to the pulsed plasma poly(vinylaniline)-cinnamaldehyde coated PET, Table 1.

A 100 μl droplet of high-purity water was placed onto 1.5 cm×1.5 cm pieces of pulsed plasma poly(vinylaniline)-cinnamaldehyde coated polypropylene cloth in a sealed tube, and the sample was left to stand for 4 h. The water droplet was removed and the water sliding angle measured again—the surface was still slippery and no change was measured for the sliding angle (within error), see Table 6 below. The same samples then had another 100 μl water droplet placed onto its surface for a further 16 h (i.e. for a total water contact time of 20 h), and again, there was no change to the water droplet sliding angle. In a separate experiment, pulsed plasma poly(vinylaniline)-cinnamaldehyde coated polypropylene cloth was fully immersed into 10 ml of high purity water for 16 h, removed, and the water droplet sliding angles were measured—this also did not affect the slipperiness of the coating, and no increase to the water droplet sliding angle was observed, see Table 6 below.

TABLE 6
Water droplet sliding angle values for porous polypropylene (PP)
cloth substrates values are reported as mean ± standard deviation.

| Surface | Sliding Angle / ° |
|---|---|
| PP cloth untreated | 36 ± 1 |
| *Cinnamaldehyde-PP cloth | . . . |
| pp VA-PP cloth | 75.3 ± 0.5 |
| pp VA-Cinnemaldehyde | 14.0 0.8 |
| pp VA-Cinnamaldehyde, 100 μl water droplet, 4 h | 13.7 ± 0.5 |
| pp VA-Cinnamaldehyde, 100 μl water droplet, 20 h | 14.0 ± 0.8 |
| pp VA-Cinnamaldehyde, immersion, 10 ml water, 16 h | 14.7 ± 0.5 |

*Samples display complete wetting/absorption of water droplets

### Benzyl Acrylate

Benzyl acrylate monomer displays the following characteristic infrared absorption bands: C—H stretching (3100-2850 cm⁻¹), aromatic ring summations (2000-1800 cm⁻¹), acrylate carbonyl C═O stretching (1720 cm⁻¹), acrylate C═C stretching (1633 cm⁻¹ and 1621 cm⁻¹), and the C—O ester stretch (1171 cm⁻¹), see FIG. 9. Similar to the alkyl acrylates, pulsed plasma deposited poly(benzyl acrylate) showed absence of the acrylate carbon-carbon double bond band, indicating that polymerisation had taken place, whereas the phenyl rings remain intact.

Pulsed plasma polymerised poly(benzyl acrylate) showed large water contact angle hysteresis and sliding angle values, Table 1. Hexadecane-infused pulsed plasma poly(benzyl acrylate) coating gave rise to lower hysteresis and sliding angles, although not particularly low. Cinnamaldehyde-, decanal-, and 2-methylundecanal-infused pulsed plasma poly(benzyl acrylate) coatings all displayed water contact angle hysteresis and sliding angles<5°. In particular, the 2-methylundecanal-infused coating showed excellent slippery properties, with a mean hysteresis of 0.5°, and a sliding angle of 2°.

### Vinylbenzyl Chloride

Vinylbenzyl chloride monomer displays the following characteristic infrared bands: C—H stretches (3095-2830 cm⁻¹), aromatic ring summations (2000-1750 cm⁻¹), vinyl C═C stretch (1630 cm⁻¹), para-substituted aromatic ring stretches (1603 cm⁻¹ and 1511 cm⁻¹), and Cl—CH₂ wag (1263 cm⁻¹), see FIG. 10. Pulsed plasma deposited poly(vinylbenzyl chloride) retained the para-substituted aromatic ring stretches (1603 cm⁻¹ and 1511 cm⁻¹), and Cl—CH₂ wag (1263 cm⁻¹) infrared bands, demonstrating high structural retention and minimal cross-linking. The vinyl C═C stretch (1630 cm⁻¹) disappeared indicating polymerisation had taken place.

Pulsed plasma poly(vinylbenzyl chloride) coated PET surface exhibited a relatively lower water contact angle hysteresis and sliding angle compared to the other styrene-type monomers investigated in this study, Table 1. Impregnation with lubricants gave rise to slippery coatings. In particular, 2-methylundecanal lubricant produced a coating with excellent water repellency, with mean contact angle hysteresis and sliding angle values of 1°. Cinnamaldehyde lubricant did not give rise to a slippery surface.

### Vinylbenzaldehyde

Vinylbenzaldehyde monomer displays the following characteristic infrared bands: C—H stretches (3090-2900 cm⁻¹), aldehyde CHO stretches (2815 cm⁻¹ and 2726 cm⁻¹), aldehyde C═O stretch (1695 cm⁻¹), vinyl C═C stretch (1630 cm⁻¹), di-substituted benzene quadrant stretch (1599 cm⁻¹ and 1582 cm⁻¹), meta-substituted benzene semicircle stretch (1478 cm⁻¹ and 1445 cm⁻¹), aldehyde CH rock (1378 cm⁻¹), meta ring stretch (1143 cm⁻¹), meta in-phase CH wag (990 cm⁻¹), and meta single CH wag (908 cm⁻¹), see FIG. 11.

Pulsed plasma deposited poly(vinylbenzaldehyde) shows good structural retention and minimal cross-linking, as indicated by the retention of the aldehyde CHO stretches (2815 cm⁻¹ and 2726 cm⁻¹), aldehyde C═O stretch (1695 cm⁻¹), meta-substituted aromatic ring semicircle stretch (1478 cm⁻¹ and 1445 cm⁻¹), and meta-substituted benzene semicircle stretch (1478 cm⁻¹ and 1445 cm⁻¹). Disappearance of the vinyl C═C stretch (1630 cm⁻¹), and the appearance of aliphatic C—H stretches (2950-2850 cm⁻¹) confirmed that polymerisation had taken place.

Pulsed plasma poly(vinylbenzaldehyde) coating showed relatively high water contact angle hysteresis and sliding angle values, Table 1. Impregnation with lubricants resulted in a significant decrease in the water contact angle hysteresis. Decanal and 2-methylundecanal also gave rise to low sliding angles (<5°). Although cinnamaldehyde and hexadecane reduced the sliding angles compared to the pulsed plasma poly(vinylbenzaldehyde)-only coating, they did not exhibit comparably low sliding angles.

Pulsed plasma poly(vinylbenzaldehyde) was coated onto porous polypropylene cloth, and impregnated with cinnamaldehyde or 2-methylundecanal lubricants, and the water droplet sliding angles were measured, as shown in the table below. Polypropylene cloth treated with 2-methylundecanal did not exhibit a slippery surface. Pulsed plasma poly(vinylbenzaldehyde) coated polypropylene cloth showed complete wetting in contact with water, which is likely due to the plasma polymer altering the surface wettability, therefore allowing the water to wick into the porous structure.

Cinnamaldehyde and 2-methylundecanal impregnated pulsed plasma poly(vinylbenzaldehyde) coated polypropylene cloth both showed slippery surfaces. The water droplet sliding angles is not as low as it was for the same coatings on the flat PET substrate surface, Table 1, which is likely due to the dimpled, rough structure of the polypropylene cloth. Placing a 100 μl water droplet onto the pulsed plasma poly(vinylbenzaldehyde)-cinnamaldehyde coated polypropylene cloth for 4 h, and then a further 16 h produced no change in water droplet sliding angle values, see Table 7 below. Immersion of the coated sample into water for 16 h also yielded no change to the sliding angle.

TABLE 7
Water droplet sliding angle values for pulsed
plasma poly(vinylbenzaldehyde) coated porous
polypropylene cloth substrates. Values are
reported as mean ± standard deviation.

| | Sliding |
|---|---|
| Surface | Angle / ° |
| PP cloth untreated | 36 ± 1 |
| 2-Methylundecanal-PP Cloth | 29.3 ± 0.5 |
| *Cinnamaldehyde-PP cloth | . . . |
| pp VBA-PP cloth | . . . |
| pp VBA-2-Methylundecanal | 12.3 ± 0.5 |
| pp VBA-Cinnemaldehyde | 15.3 + 0.5 |
| pp VBA-Cinnamaldehyde, 100 μl water droplet, 4 h | 14.3 ± 0.5 |
| pp VBA-Cinnamaldehyde, 100 μl water droplet, 20 h | 14.7 ± 0.9 |
| pp VBA-Cinnamaldehyde, immersion, 10 ml water, 16 h | 14.3 ± 0.5 |

*Samples display complete wetting/absorption of water droplets

### Vinylpyridine

Infrared spectroscopy of vinylpyridine monomer showed the following characteristic bands: C—H stretches (3100-2885 cm⁻¹), ring summations (2000-1700 cm⁻¹), vinyl C═C stretching (1633 cm⁻¹), aromatic quadrant C═C stretching (1595 cm⁻¹ and 1547 cm⁻¹), aromatic semicircle C═C and C═N stretching (1494 cm⁻¹ and 1408 cm⁻¹ respectively), and vinyl=CH₂ wag (922 cm⁻¹), see FIG. 12. Pulsed plasma deposited poly(vinylpyridine) showed good structural retention, with the disappearance of the vinyl group bands indicating that polymerisation had taken place.

Pulsed plasma poly(vinylpyridine)-only coatings were hydrophilic and showed water droplet pinning on the receding angles. Contact angle hysteresis for pulsed plasma poly(vinylpyridine) demonstrated that all the tested lubricants (cinnamaldehyde, decanal, 2-methylundecanal, and hexadecane) failed to infuse into the poly(vinylpyridine) plasma polymer and produce slippery coatings, and also demonstrated that the poly(vinylpyridine) coating showed preferential wetting with water, see Table 8, below. Cinnamaldehyde caused at least partial washing off or dissolving of the coating, as determined by the loss of the brown colour of the coating (hence the lack of pinning on receding angles). Perfluorotributylamine failed to make the coating slippery, as seen from qualitative assessment of the sliding angle (quantitative analysis of contact angle hysteresis and sliding angle was not measured).

TABLE 8
Water droplet static, advancing, receding, hysteresis
contact angle values following lubricant impregnation
of pulsed plasma poly(vinylpyridine)-coated PET substrates.
Pulsed plasma poly(vinylpyridine)-coated PET surface
is included as a control. Values are reported as
mean ± standard deviation.

| | Contact Angle / ° | | | |
|---|---|---|---|---|
| Surface | Static | Advancing | Receding | Hysteresis |
| Pulsed Plasma Poly | 38 ± 5 | 57.4 ± 0.5 | 0 ± 0 (Pinned) | 57.4 ± 0.5 |
| (vinylpyridine) | | | | |
| (pp VP) | | | | |
| pp VP- | 65 ± 9 | 73 ± 8 | 36 ± 10 | 38 ± 13 |
| Cinnamaldehyde | | | | |
| pp VP-Decanal | 53 ± 5 | 69 ± 6 | 0 ± 0 (Pinned) | 69 ± 6 |
| pp VP-2- | 49 ± 3 | 60 ± 3 | 0 ± 0 (Pinned) | 60 ± 3 |
| Methylundecanal | | | | |
| pp VP-Hexadecane | 43 ± 7 | 55 ± 10 | 0 ± 0 (Pinned) | 55 ± 10 |

### Glycidyl Methacrylate

For glycidyl methacrylate monomer, the following characteristic infrared band assignments were as follows: epoxide ring C—H stretching (3062 cm⁻¹), C—H stretching (3000-2880 cm⁻¹), acrylate carbonyl C═O stretching (1714 cm⁻¹), acrylate C═C stretching (1638 cm⁻¹), epoxide ring breathing (1253 cm⁻¹), antisymmetric epoxide ring deformation (908 cm⁻¹), and symmetric epoxide ring deformation (842 cm⁻¹), see FIG. 13. Loss of the acrylate carbon-carbon double bond after pulsed plasma deposition showed that polymerisation had successfully taken place. The epoxide bands are still visible, indicating good structural retention.

None of the tested lubricants produced slippery surfaces with the pulsed plasma poly(glycidyl methacrylate) coating, see Table 9, below. In fact, they all resulted in an increase to the water contact angle hysteresis compared to the pulsed plasma poly(glycidyl methacrylate)-only coating. Since the coatings were not slippery, sliding angles were not measured.

Table 9: Water droplet static, advancing, receding, and hysteresis
contact angle values following lubricant impregnation of pulsed
plasma poly(glycidyl methacrylate)-coated PET substrates. Pulsed
plasma poly(glycidyl methacrylate)-coated PET surface is included
as a control. Values are reported as mean ± standard deviation.

| | Contact Angle / ° | | | |
|---|---|---|---|---|
| Surface | Static | Advancing | Receding | Hysteresis |
| Pulsed Plasma Poly | 56 ± 2 | 58.9 ± 0.1 | 37.3 ± 0.8 | 21.6 ± 0.8 |
| (GMA) (ppGMA) | | | | |
| ppGMA- | 68 ± 2 | 70 ± 2 | 35 ± 2 | 35 ± 3 |
| Cinnamaldehyde | | | | |
| ppGMA-Decanal | 68.1 ± 0.4 | 71.6 ± 0.7 | 34 ± 4 | 38 ± 4 |
| ppGMA-2-Methyl- | 57.0 ± 1.7 | 62 ± 4 | 38.7 ± 1.3 | 23 ± 4 |
| undecanal | | | | |
| ppGMA-Hexadecane | 75.1 ± 0.7 | 79.5 ± 0.9 | 38 ± 5 | 42 ± 5 |

### Pentafluorostyrene

Pentafluorostyrene monomer infrared spectra showed the following characteristic bands: vinyl C═C stretch (1625 cm⁻¹), fluorinated aromatic ring vibrations (1519 cm⁻¹ and 1492 cm⁻¹), C—F (aromatic) stretching (973 cm⁻¹), and vinyl=CH₂ wag (927 cm⁻¹), see FIG. 14. Disappearance of the vinyl group bands in the pulsed plasma deposited poly(pentafluorostyrene) showed that polymerisation had successfully taken place.

Pulsed plasma poly(pentafluorostyrene) coated PET substrates were treated with fluorinated lubricants—Perfluorotributylamine and Perfluoropolyether—but it was found that they did not produce slippery surfaces, and in fact the lubricants appeared to increase the water contact angle hysteresis compared to the pulsed plasma poly(pentafluorostyrene)-only coating, see Table 10 below. Since the coatings were not slippery, sliding angles were not measured.

TABLE 10
Water droplet static, advancing, receding, and hysteresis contact
angle values following lubricant impregnation of pulsed plasma
poly(pentafluorostyrene)-coated PET substrates. Pulsed plasma
poly(pentafluorostyrene)-coated PET surface is included as a
control. Values are reported as mean ± standard deviation.

| | Contact Angle / ° | | | |
|---|---|---|---|---|
| Surface | Static | Advancing | Receding | Hysteresis |
| Pulsed Plasma | 96 ± 3 | 105.5 ± 1.0 | 76.4 ± 0.9 | 29.1 ± 1.4 |
| Poly(penta- | | | | |
| fluorostyrene) | | | | |
| (ppPFS) | | | | |
| ppPFS-Fluorinert | 116.7 ± 0.5 | 121.1 ± 0.7 | 79 ± 7 | 43 ± 7 |
| ppPFS- | 113.8 ± 1.3 | 117.9 ± 0.6 | 87.7 ± 1.9 | 30 ± 2 |
| Perfluoropolyether | | | | |

### 1H, 1H, 2H, 2H-Perfluorooctyl Acrylate

1H, 1H, 2H, 2H-perfluorootcyl acrylate monomer infrared characteristic peaks were observed as follows: C—H stretching (2975 cm⁻¹), acrylate carbonyl C═O stretch (1732 cm⁻¹), C═C stretching (1638 cm⁻¹), and C—F stretching (1260-1100 cm⁻¹), see FIG. 15. The carbon-carbon double bond bands disappeared upon plasma polymerisation, indicating that polymerisation was successful.

None of the pulsed plasma poly(1H, 1H, 2H, 2H-perfluorootcyl acrylate) coated samples produced slippery surfaces when immersed into either of the fluorinated lubricants, see Table 11 below. Perfluoropolyether did reduce the water contact angle hysteresis somewhat compared to the poly(1H, 1H, 2H, 2H-perfluorootcyl acrylate)-only coated surface, but the hysteresis was still relatively high. Since the coatings were not slippery, sliding angles were not measured.

TABLE 11
Water droplet static, advancing, receding, and hysteresis contact angle
values following lubricant impregnation of pulsed plasma poly(1H, 1H,
2H, 2H-perfluorootcyl acrylate)-coated PET substrates. Pulsed plasma
poly(1H, 1H, 2H, 2H-perfluorootcyl acrylate)-coated PET surface is included
as a control. Values are reported as mean ± standard deviation.

| | Contact Angle / ° | | | |
|---|---|---|---|---|
| Surface | Static | Advancing | Receding | Hysteresis |
| Pulsed Plasma 1H, 1H, 2H, | 122 ± 3 | 124 ± 4 | 45 ± 6 | 79 ± 9 |
| 2H-perfluorootcyl acrylate | | | | |
| (ppPFAC6) | | | | |
| ppPFAC6-Fluorinert | 121.7 ± 0.3 | 135.2 ± 1.2 | 64 ± 2 | 72 ± 3 |
| ppPFAC6-Perfluoropolyether | 117 ± 3 | 121.4 ± 1.8 | 89 ± 4 | 33 ± 5 |

### Anti-Biofouling Studies

### Experimental

Further lubricant infused surfaces were screened for antifouling/antibiofouling properties and it is shown that at least vacuum pump oil and squalane infused pulsed plasma poly(styrene) (ppPS) can effectively prevent biofouling for at least 7 days. In this particular study, only one substrate material was required to investigate the production of slippery lubricant-infused surfaces: Polyester (Polyethylene terephthalate/PET) film (Mylar A 125, DuPont Teijin Films U.K. Ltd.).

One pulsed plasma monomer was used to form slippery surfaces, styrene (+99%, Sigma-Aldrich Ltd.). Pulsed plasma deposition parameters are: pulse on-time=100 μs, pulse off-time=4 ms, peak power=40 W, deposition time=30 min, pressure=0.2 mbar. In order to produce slippery surfaces, substrates (PET, and ppPS PET) were placed in neat lubricant for 15 min and then shaken in deionised water for 5 min and dried vertically for at least 3 h in order to allow any excess lubricant to drip off. In order to quantify the degree of fouling of each sample, a colourimeter was used (model PCE-CSM 4, PCE Instruments UK Ltd). A large plastic tank filled with water from a natural water pond (“biofouling tank”) was used for outdoor biofouling experiments.

### Results

For lubricant infused PET control surfaces, a change in water contact angle occurs but these surfaces generally lack slippery behaviour (likely due to incomplete wetting of the surface by the lubricant). Exceptions are for 1-undecanol and decanal infused PET, low water contact angle hysteresis (<5°) and sliding angle (<5°) values are observed.

Whereas the impregnation of pulsed plasma poly(styrene) (ppPS) coated PET substrates with a variety of lubricants produces slippery surfaces with low water contact angle hysteresis (<5°) and sliding angle (<5°) values. Through the choice of lubricant, the wettability (water contact angle value) of the surface can be tuned for different applications whilst maintaining slippery behaviour. FIGS. 16 a)-c) illustrate water repellency of PET and ppPS coated PET substrates when no lubricant is used and when infused with a variety of lubricants, in particular, FIG. 16 a) illustrates water contact angle values for 2 μL high purity water droplets; FIG. 16 b) illustrates water contact angle hysteresis values; and FIG. 16 c) illustrates sliding angle values for 50 μL high purity water droplets.

A number of different lubricant infused coatings have been used in biofouling experiments, and it is shown that lubricant (2-methylundecanal, squalane, and vacuum pump oil) infused ppPS coatings resisting fouling adhesion, shown in FIGS. 17a-c. in particular, FIGS. 17a-c illustrate biofouling results using ppPS coated PET control and infused with various lubricants: (a) (1-undecanol, 2-methylundecanal and eugenol); (b) (rapeseed oil, decanal and vacuum pump oil); and (c) (olive oil, squalane and 2-methylundecanal) showing photographs before and after 7 days of water immersion in the biofouling tank (water temperature: 5-10° C.). FIG. 17d illustrates the measured colour change quantity value of ppPS control and infused with various lubricants (squalane, 2-methylundecanal, decanal, 1-undecanol, eugenol, rapeseed oil, olive oil, vacuum pump oil) after 7 days of immersion of in the biofouling tank (water temperature: 5-10° C.). Squalane is a saturated hydrocarbon compound with an extremely low water solubility. Vacuum pump oil is a mixture of different hydrocarbons and the water solubility value is low. Based on the results presented here, low water solubility of lubricant is likely to be a key characteristic required of liquid infused slippery surfaces for antifouling/antibiofouling.

ppPS coated PET samples with no lubricant show a significant decrease in water contact angle value following biofouling tank immersion—likely due to the biofouling of the surface. The biofouling of the ppPS coated PET samples with no lubricant infusion causes higher water contact angle hysteresis and sliding angle values than for the same surface prior to biofouling tank immersion, see FIGS. 16 and 18. FIG. 18 illustrates water contact angle, water contact angle hysteresis, and sliding angle values for ppPS coated PET control and infused with various lubricants (squalane, 2-methylundecanal, and vacuum pump oil) following 7 days of immersion in the biofouling tank (water temperature: 5-10° C.). Following 7-day immersion in the biofouling tank, both the water contact angle hysteresis and sliding angle values for the lubricant infused ppPS coated PET surfaces are much lower than for the control. The squalane and vacuum pump oil lubricants retain both low water contact angle hysteresis and sliding angle values (<5°). The extremely low water solubility of the squalane may prevent dissolution of the lubricant layer into the surrounding fluid, creating a more slippery interface.

### Regeneration of Squalane-Infused Slippery Surfaces

Following on from demonstrating that slippery lubricant infused surfaces can be created through the impregnation of liquids into pulsed plasma polymer layers, an example of a low water solubility lubricant, squalane was infused into pulsed plasma poly(styrene) surfaces and shown to prevent fouling during 7-day immersion in the biofouling tank. The chemical structure of squalene is shown below:

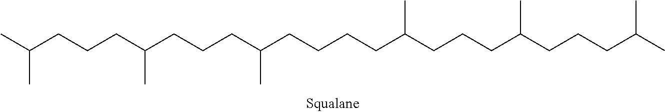 [SMILES: CC(C)CCCC(C)CCCC(C)CCCCC(C)CCCC(C)CCCC(C)C]

A potential limitation of such liquid infused surfaces is that lubricant layer could eventually leach out into the surrounding bulk fluid leading to the loss of the protective liquid intermediary layer, and so a strategy to replenish the lubricant layer of submerged surfaces is presented using a stream of air bubbles that has been passed through lubricant.

### Experimental

Two substrate materials have been used to investigate the production of slippery surfaces: polyester (Polyethylene terephthalate/PET) film (Mylar A 125, DuPont Teijin Films U.K. Ltd.); and Glass microscope slide (Academy Microscope Slides, Academy Science Co.). For the pulsed plasmachemical deposition onto various substrates, styrene (+99%, Sigma-Aldrich Ltd.) monomer was used. Pulsed plasma deposition parameters are: pulse on-time=100 μs, pulse off-time=4 ms, peak power=40 W, deposition time=30 min, pressure=0.2 mbar.

To demonstrate the ability of the ppPS coatings to regenerate slippery behaviour whilst in submerged applications, tests were performed in which ppPS coated PET was exposed to an air bubble stream that was passed through lubricant. In order to do this, a solar powered air pump (model no. BSV-AP002, Shenzhen SanShang Technology Company) was connected to a gas flowrate meter model (Flostat NG, CT Platon Ltd) fitted with a metering valve (model MN, CT Platon Ltd) via a 40 cm length of PVC gas tubing. Another 65 cm length of PVC gas tubing connected the gas flowrate meter to the air inlet of a cylindrical glass chamber, shown in FIG. 19. 3 mL of squalane was pipetted into the 65 cm length of gas tubing, the squalane lubricant stuck to the side walls of the PVC tubing and a small reservoir pooled in the middle of the tube. The lubricant filled tube was fitted through the air inlet of the cylindrical glass chamber. The solar powered air pump was then turned on and air allowed to flow through the system at 200 cm³ min⁻¹. Following this the air passed through the lubricant trapped in the tubing but it did not cause all of the lubricant to be expelled from the tubing. Tap water was then used to gradually fill the cylindrical glass chamber to 17 cm above the air inlet whilst also adjusting the metering valve to ensure a gas flowrate of 200 cm³ min⁻¹. Once the chamber was filled, a pair of clean tweezers were used to hold a 25 mm by 25 mm square sample of ppPS PET horizontally over the gas bubble stream at a depth of 5 cm for 2 min. Following bubble exposure, the sample was removed from the water and allowed to dry vertically for 1 h.

### Results

Following 2 min exposure of ppPS coated PET samples to air bubbles that have been passed through squalane lubricant coated tubing, an increase in water contact angle value and decrease in water contact angle hysteresis and sliding angle values compared with the ppPS coated PET with no squalane lubricant infusion is observed, shown in FIG. 20, which illustrates water contact angle, water contact angle hysteresis and sliding angle values for ppPS coated PET, ppPS coated PET infused with squalane by neat lubricant immersion, and ppPS coated PET infused with squalane by air bubble transport whilst submerged.

The slippery behaviour (low water contact angle hysteresis and sliding angle values) of the ppPS coated PET surface following 2 min exposure to air bubbles that had travelled through a reservoir of squalane is comparable to that of the previous conventional preparation of squalane infused ppPS coated PET slippery surface. This demonstrates that lubricant can be effectively impregnated into the coating in an underwater environment in order to improve the long-term antifouling/antibiofouling capabilities of slippery liquid infused surfaces by replacing trapped lubricant that has been lost due to any leaching into the bulk fluid. The bubbles serve to transport the lubricant to the surface and may also provide an additional antifouling/antibiofouling effect by creating shear forces and removing organisms that may have attached to the surface.

### Discussion

Superhydrophobic surfaces are typically characterized as having low water contact angle hysteresis values. For example, this can be achieved by combining a hydrophobic surface and topographical micro- and/or nanostructure (roughness)—which effectively traps an air layer on the surface. Natural world examples of such highly repellent and self-cleaning surfaces include the Lotus leaf (Nelumbo nucifera). However, these surfaces can fail when subjected to high pressures, and therefore are unable to mitigate bacterial adhesion and biofouling under such conditions. This is attributed to displacement of the trapped air pockets, exposing the underlying rough surface—which can be favourable towards bacterial colonization.

Pulsed plasma deposited poly(hexyl acrylate) has been found to display slippery behaviour (low water contact angle hysteresis (<10°) and sliding angle (<10°) values, Table 1. Whereas pulsed plasma deposited poly(butyl acrylate) and poly(isooctyl acrylate) coatings do not. One possible rationalisation for these results is that there exists an optimum alkyl chain length to produce a slippery surface—if the alkyl chain is too long, then intermolecular forces between neighbouring chains dominate, and the coating surface is solid-like; whilst if the chain length is too short, then the alkyl chains cannot prevent water from interacting with the relatively more polar polymer backbone acrylate groups, leading to increased surface adhesion of the water molecules. Hence an optimum alkyl group chain length effectively screens the polar acrylate groups from water molecules, while also exhibiting weak (liquid-like) interactions between surface alkyl chains. In effect, the pulsed plasma poly(hexyl acrylate) coating behaves as a covalently attached slippery liquid.

Lubricants impregnated into non-porous hydrocarbon polymer films via wicking of the lubricant into the polymer matrix on a molecular level (without any prior treatment of the polymer solid surface) can also lead to slippery surfaces (low water contact angle hysteresis). This slipperiness is not due to excess lubricant remaining on the surface, and can be stable for prolonged periods of time (provided that the surface and lubricant polarities are well matched). In a similar way, functional pulsed plasma polymer film coatings have been shown to form slippery surfaces by wicking of lubricants into the deposited layer, with the added advantage of being independent of substrate material and geometry, Table 1.

Nonaromatic (aliphatic) pulsed plasma polymer coatings (i.e. poly(hexyl acrylate), poly(glycidyl methacrylate), and poly(1H, 1H, 2H, 2H-perfluorootcyl acrylate)) all exhibit a tendency not to form lubricant-infused slippery surfaces, whereas aromatic group containing pulsed plasma polymer coatings do. Previous studies have shown that aromatic-aliphatic interactions can be significantly stronger than aliphatic-aliphatic and aromatic-aromatic interactions. It is therefore likely that the aromatic group containing plasma polymer coatings interact more strongly with the lubricants than the aliphatic group containing plasma polymers, leading to slippery surface formation in the former case, but not for the latter.

Out of the three fluorinated pulsed plasma polymer coatings investigated (perfluoroallylbenzene, pentafluorostyrene, and 1H, 1H, 2H, 2H-perfluorootcyl acrylate), only the first one yielded a slippery surface when combined with fluorinated lubricants. The latter two contain carbon-hydrogen and carbon-oxygen bonds which most likely act to hinder the compatibility of the fluorinated lubricants with the pulsed plasma polymer host matrix; whereas perfluoroallylbenzene is fully fluorinated, meaning it has good compatibility with the perfluorotributylamine and perfluoropolyether lubricants—thereby highlighting the importance of the surface chemistry/energy matching with the lubricant. US Food and Drug Administration (FDA) approved perfluorodecalin lubricant also produced a slippery surface when combined with pulsed plasma poly(perfluoroallylbenzene), Table 1. Such slippery surfaces could provide protection against chemical and biological warfare agents as well as offering bloodphobicity for healthcare applications.

Pulsed plasma poly(vinylpyridine) failed to form a slippery lubricant-infused surface when treated with lubricants. Pyridine is a relatively strong basic compound, with a pKₐ value of 5.2, and can lead to hydrogen-bond formation (due to the nitrogen lone-pair electrons, which are orthogonal to the aromatic T orbitals, and therefore do not donate any electron density into aromatic π orbitals orbitals). Indeed, pulsed plasma poly(vinylpyridine) has previously been described as ‘superhydrophilic’ and displays preferential wetting by water.

Furthermore, it has been reported that spin-coated poly(vinylpyridine) did not form a slippery surface with silicone oil lubricant due to preferential wetting by water. In contrast, pulsed plasma poly(vinylaniline), which contains a relatively polar amine group, has been shown in the present study to successfully form slippery surfaces, Table 1. The reason is that the nitrogen lone pair in the aniline ring is able to delocalise via resonance into the aromatic π system, giving rise to lower pKₐ value of only 4.6, and the amine group does not form hydrogen bonds with water as readily as for the vinylpyridine system. This manifests in the relatively higher static water contact angle for pulsed plasma poly(vinylaniline) versus pulsed plasma poly(vinylpyridine) (75° and 38° respectively, Table 1). Similarly, glycidyl methacrylate contains a polar epoxide group, and pulsed plasma poly(glycidyl methacrylate) exhibits a fairly low static water contact angle (i.e. it is hydrophilic), and thus does not form a slippery lubricant-infused coating.

Pulsed plasma polymer slippery lubricant infused surface produced on porous polypropylene cloth showed improved resistance towards leaching of lubricant into water, Table 6. It has previously been reported that this particular cloth can absorb 45±4 mg cm⁻² of cinnamaldehyde, meaning that there is a ‘reservoir’ of cinnamaldehyde contained within the bulk of the cloth that can move to the surface to replenish any lost lubricant. This could have potential applications in underwater slippery surfaces, such as preventing marine biofouling or manipulation of air bubbles.

The successful production of slippery lubricant-infused surfaces on drop-cast polystyrene and pre-formed polystyrene plastic (from Petri dishes) demonstrates that this approach is not only limited to plasma polymer coatings, but could potentially be applicable to a range of alternative surface functionalisation methods including: atomised spray plasma deposition, initiated chemical vapour deposition, electron/ion beam deposition, self-assembled layers, as well as other dry (solventless) and wet surface coating methods. A variety of additional lubricants could also be employed, for example: non-volatile ionic liquids. Furthermore, the rechargeable pulsed plasma polymer-antimicrobial lubricant slippery surfaces could find application in re-usable air filtration systems and personal protective equipment clothing for healthcare.

### Pulsed Plasma Octamethylcyclotetrasiloxane Slippery Surfaces

Further to pulsed plasma poly(hexyl acrylate) (ppHA) exhibiting slippery behaviour without the requirement for any lubricant impregnation, pulsed plasma deposition using octamethylcyclotetrasiloxane, (OMCTS) is used to produce slippery surfaces with low water contact angle hysteresis (<5°) and sliding angle (<5°) values without lubricant impregnation. OMCTS has the chemical structure shown below:

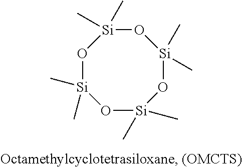

Biofouling tests show that pulsed plasma octamethylcyclotetrasiloxane (ppOMCTS) coatings are effective at reducing fouling.

### Experimental

The following substrate material has been used: Glass microscope slide (Academy Microscope Slides, Academy Science Co.). As an example of a siloxane-group containing monomer, pulsed plasmachemical deposition of octamethylcyclotetrasiloxane (OMCTS, 98%, Sigma-Aldrich Ltd.) is prepared. Pulsed plasma deposition parameters are: pulse on-time=variable μs, pulse off-time=20 ms, peak power=40 W, deposition time=10 or 30 min, pressure=0.2 mbar. A large plastic tank filled with water from a natural water pond was used for outdoor biofouling experiments.

### Results

Following pulsed plasma deposition using octamethylcyclotetrasiloxane (ppOMCTS) onto glass microscope slides, an increase in water contact angle values (from ˜37° to ˜103°) was observed which is consistent with the deposition of low surface energy siloxane groups onto surface of the glass substrates. As well as the increase in hydrophobicity due to the deposition of siloxane groups, a significant decrease in water contact angle hysteresis and sliding angle values was observed compared with the uncoated glass.

The surface displaying the most slippery behaviour with the minimum water contact angle value (2.2±1.6°) and sliding angle value (1.3±0.5°) was produced with an on time of 200 s. This is due to functional group retention of the coating, and can be further optimised by varying plasma process conditions or using alternative monomer excitation sources (microwave plasma, atmospheric pressure plasma, dielectric barrier discharge, atomised spray plasma deposition, initiated chemical vapour deposition, electron beam grafting). By tuning the plasma process conditions, the water contact angle hysteresis value can be improved to 0.8±0.1° with a sliding angle value of 1.0±0.0°. FIG. 21 demonstrates the water contact angle, water contact angle hysteresis and sliding angle values for pulsed plasma deposition using OMCTS ppOMCTS coated glass microscope slides with various on times (off time=20 ms). For small water contact angle error bars, the error bars are obscured by the data point symbol.

Three samples of ppOMCTS coated glass slides were tested for antifouling/antibiofouling activity against an untreated glass microscope slide (control) by immersing samples for 7 days in a biofouling tank, see FIG. 22, which shows the colour change of results using glass microscope slides uncoated versus pulsed plasma plasma OMCTS coated before and after 7 days of immersion in a biofouling tank. These results show that slippery ppOMCTS coatings can reduce fouling without lubricant impregnation, although impregnation of ppOMCTS surfaces with oils such as silicone oil to prepare slippery surfaces can also provide antifouling/antibiofouling behaviour. Substrate location downstream from the plasma excitation or remote plasma deposition enhances slippery behaviour (low water contact angle hysteresis and low water droplet sliding angle) leading to reduced biofouling. This can be attributed to the synergistic effect of ultra low energies of pulsed plasmas combined with on moving downstream beyond the direct plasma excitation zone (remote plasma) leading to reduced exposure of monomer molecules and the deposited coating towards excited plasma species (photons, electrons, ions, and metastables) culminating in less fragmentation, crosslinking, or damage. Ultra low energy pulsed plasmas or downstream location of the substrate beyond the direct plasma excitation zone (remote plasma) reduces exposure of monomer molecules and the deposited coating towards excited plasma species (photons, electrons, ions, and metastables) culminating in less fragmentation, crosslinking, or damage; and this provides in-situ generation of low molecular weight oligomer lubricant species entrapped within the deposited coating.

### CONCLUSIONS

The present invention therefore provides a range of slippery surfaces by combining different functional pulsed plasma polymer layers and lubricants. The process involves a simple, quick, substrate-independent, two-step methodology. Hydrophilic pulsed plasma polymer coatings are found not to produce slippery lubricant-infused coatings. Structure-behaviour relationship shows that aromatic-aliphatic interactions between coating and lubricant are favoured. Fluorinated lubricant-infused coatings display omniphobicity and repel liquids with a range of surface tensions (including water, heptane and motor oil). Natural antimicrobial compound cinnamaldehyde-infused pulsed plasma polymer surfaces give rise to concurrent antibacterial activity against both Gram-positive Staphylococcus aureus and Gram-negative Escherichia coli. In addition, these lubricant-infused pulsed plasma polymer surfaces are found to repel a range of everyday liquid foodstuffs (such as tomato ketchup and honey). In some aspects of the invention, slippery surfaces are demonstrated including siloxane-group containing monomers, in particular, OMCTS, which do not necessarily require impregnation with lubricant to achieve the desired effect, and further, in some examples, lubricant may be generated concurrently (in situ) during deposition of the polymer layer.

What is claimed is:

1. A liquid repellent slippery surface, said surface comprising:
a substrate and associated substrate surface;
said substrate surface functionalised via the deposition of a polymer layer thereon; and
a lubricant impregnated into the polymer layer, thereby forming said liquid repellent slippery surface,
wherein said polymer layer comprises an aromatic ring-containing polymer layer, and said lubricant is an aliphatic compound, rapeseed oil, olive oil, vacuum pump oil, cinnamaldehyde, a cinnamaldehyde derivative, essential oil or an essential oil-derived compound.

2. A liquid repellent slippery surface according to claim 1, wherein said liquid repellent slippery surface is provided to have antimicrobial, antibacterial, antifungal, antifouling, antibiofouling, antiviral, drag reduction and/or antiparasitic properties.

3. A liquid repellent slippery surface according to claim 1, wherein said liquid repellent slippery surface is defined as having a liquid contact angle hysteresis value of 10° or less, and a liquid sliding angle of 10° or less.

4. A liquid repellent slippery surface according to claim 1, wherein said polymer layer is formed from aromatic ring-containing functional monomer precursors.

5. A liquid repellent slippery surface according to claim 1, wherein said substrate is a non-porous substrate, and comprises any of the following: polyethylene terephthalate (PET), polypropylene, polyethylene, polystyrene, polyvinyl chloride, nylon, Teflon/polytetrafluoroethylene, polyurethanes, polylactic acid, polyisoprene, polybutadiene, natural rubber, poly(methyl methacrylate), polyimides, any other plastics, copolymers, polysiloxanes; metals such as aluminium, copper, steel; wood, quartz, cotton, wool, ceramics, linoleum, paper/cellulose, cement, textiles, silicon wafer, or glass.

6. A liquid repellent slippery surface according to claim 1, wherein said polymer layer is formed from any functional monomer precursor from the group including: styrene, benzyl acrylate, vinylbenzaldehyde, vinylbenzyl chloride, perfluoroallylbenzene; pentafluorostyrene; vinylaniline, or vinylpyridine.

7. A liquid repellent slippery surface according to claim 1, wherein lubricant is antimicrobial, antibacterial, antifungal, antifouling, antibiofouling, antiviral and/or antiparasitic.

8. A liquid repellent slippery surface according to claim 1, wherein said lubricant is selected from the group including: squalane; hexadecane 2-methyl-undecanal; 1-undecanol; decanal; geraniol; perfluorotributylamine; perfluoropolyether; perfluorodecalin; rapeseed oil; olive oil; vacuum pump oil; cinnamaldehyde; a cinnamaldehyde derivative, essential oil or an essential oil-derived compound.

9. A liquid repellent slippery surface, said surface comprising:
a substrate and associated substrate surface; and
a lubricant provided on the substrate surface, thereby forming said liquid repellent slippery surface;
wherein said substrate surface includes an aromatic ring-containing compound.

10. A liquid repellent slippery surface according to claim 9, wherein said substrate surface is formed from a compound comprising aromatic ring-containing groups.

11. A liquid repellent slippery surface according to claim 10, wherein, said substrate surface is formed from poly(styrene), or said substrate, and hence substrate surface, is formed from poly(styrene).

12. A liquid repellent slippery surface according to claim 9, wherein said substrate surface is functionalised via the deposition of a polymer layer thereon, said polymer layer formed from a functional monomer precursor containing an aromatic ring-containing group.

13. A liquid repellent slippery surface according to claim 12, wherein said polymer layer is formed from any functional monomer precursor from the group including: styrene, benzyl acrylate, vinylbenzaldehyde, vinylbenzyl chloride, perfluoroallylbenzene; pentafluorostyrene; vinylaniline, or vinylpyridine.

14.-22. (canceled)

23. A liquid repellent slippery surface, said surface comprising:
a substrate and associated substrate surface;
said substrate surface functionalised via the deposition of a polymer layer thereon; and
wherein said polymer layer is formed from a functional monomer precursor comprising a siloxane-group containing monomer or an alkyl-group containing monomer.

24. A liquid repellent slippery surface according to claim 23, wherein said monomer precursor is provided to be octamethylcyclotetrasiloxane (OMCTS).

25. A liquid repellent slippery surface according to claim 23, wherein said liquid repellent slippery surface further includes a lubricant formed concurrently (in situ) with said polymer layer.

26. A liquid repellent slippery surface according to claim 25, wherein said lubricant is provided to be a low molecular weight oligomer formed from the same monomer precursor which forms the polymer layer.

27. A liquid repellent slippery surface according to claim 23, wherein said liquid repellent slippery surface is defined as having a liquid contact angle hysteresis value of 10° or less, and a liquid sliding angle of 10° or less

28. A liquid repellent slippery surface according to claim 23, wherein said liquid repellent slippery surface is provided to have antifouling properties.

29. A liquid repellent slippery surface according to claim 23, wherein said liquid repellent slippery surface further includes a lubricant impregnated into the polymer layer, further increasing the liquid repellent slippery properties thereof.

30.-31. (canceled)
